(19) United States
(12) Patent Application Publication
(10) Pub. No.: US 2026/0191237 A1
(43) Pub. Date: Jul. 9, 2026

(54) NATURAL FOOD-GRADE RED COLOR COMPRISING ROSEMARY AND GREEN TEA EXTRACT

(71) Applicant: KEMIN INDUSTRIES, INC., DES MOINES, IA (US)

(72) Inventors: Stephen D. Kelleher, Ipswich, MA (US); William R. Fielding, Hilton Head, SC (US); Chia-Yu Shen, Ames, IA (US); Ying Joy Zhong, Ankeny, IA (US); Amy Philavanh, Des Moines, IA (US)

(73) Assignee: KEMIN INDUSTRIES, INC., DES MOINES, IA (US)

(21) Appl. No.: 19/402,519

(22) Filed: Nov. 26, 2025

Related U.S. Application Data
(60) Provisional application No. 63/725,180, filed on Nov. 26, 2024.

(51) Int. Cl. A23L 5/43

(52) U.S. Cl. CPC A23L 5/43

(57) ABSTRACT

The present invention relates to a natural, food-grade red color composition that is a suitable alternative to artificial red food color for food products. In certain embodiments, the composition contains at least two polyphenols, wherein at least one polyphenol is a phenolic diterpene. In certain embodiments, the composition is a blend of rosemary extract and green tea extract. According to at least one embodiment, beet powder is added to the composition. One aspect of the present invention relates to a natural red color that is heat-resistant. Another aspect of the present invention relates to a natural red color that can withstand exposure to light. Another aspect of the present invention relates to a natural red color that maintains its color intensity even after prolonged exposure to heat and/or light. Another aspect of the present invention relates to a natural red color that is suitable for pH ranges typical of foods.

### CROSS-REFERENCE TO RELATED APPLICATIONS

The present application claims the benefit of priority to U.S. Provisional Patent Application No. 63/725,180, filed Nov. 26, 2024, entitled “NATURAL FOOD-GRADE RED COLOR COMPRISING ROSEMARY AND GREEN TEA EXTRACT,” and claims the benefit of priority to U.S. Provisional Patent Application No. 63/618,166, filed Jan. 5, 2024, entitled “NATURAL FOOD-GRADE RED COLOR COMPRISING ROSEMARY AND GREEN TEA EXTRACT,” the entire disclosure of which is hereby incorporate by reference in its entirety.

### BACKGROUND OF THE INVENTION

There are presently two broad groups of red colors available for use in food products. “Artificial” or synthetic red color, which is derived mostly from petroleum products, and “Natural” red color, which may be extracted from plants or insects. The red hue of artificial dyes and/or natural red colors comes from their conjugated aromatic chromophores maximumly absorbing wavelength between 490-560 nm in visible region.

Artificial (or synthetic) red dye is effective as a colorant but has possible health concerns and at times creates labeling requirements. For instance, Red No. 40 dyes are banned in foods meant for infants in the European Union (EU) and as of 2010 the EU requires most foods containing artificial red dyes to have on their label that the food contained within “may have an adverse effect on activity and attention in children.” Additionally, due to these concerns, as well as concern over artificial red dyes being potentially carcinogenic, the State of California has announced that beginning in 2027, it will no longer allow foods sold in the state to contain Red No. 3 food dye (California Food Safety Act, Assembly, Bill 418). More recently, on Apr. 22, 2025, the United States Food and Drug Administration (FDA) announced the mandatory phase-out of petroleum-based synthetic dyes from the food supply. See https://www.fda.gov/news-events/press-announcements/hhs-fda-phase-out-petroleum-based-synthetic-dyes-nations-food-supply.

These bans have prompted industry commitments and pledges to remove petroleum-based food dyes. See https://www.fda.gov/food/color-additives-information-consumers/tracking-food-industry-pledges-remove-petroleum-based-food-dyes. The bans have also prompted renewed interest in identifying a food-grade, natural or clean-label red color. But when evaluating red color derived from natural sources, there is limited diversity. There are technical hurdles, where natural colors tend to breakdown and fade in intensity and change in color over storage time, leading to an undesirable appearance. With that in mind, suitable colors are typically judged for their stability, and more specifically, the ability to withstand abuse from light or heat, as well as suitability across varying pH and temperature ranges, including but not limited to those ranges associated with meat. As per the United States Food & Drug Administration (FDA), natural colors derived from natural substances fall under the “additives exempt from certification” category which negates their certification from FDA. See “Color Additives in Foods,” herein incorporated by reference, available at www.fda.gov/food/color-additives-information-consumers/color-additives-foods.

Even before the heightened consumer awareness and government-imposed bans, for years, researchers have searched for natural alternatives to Red No. 3, and Red No. 40. Despite the decades-long effort, to date, no alternative has been identified that can withstand the high temperatures associated with manufacturing and the pH ranges associated with food products. For instance, researchers have considered natural ingredients that may be able to impart a red color, such as beet juice, beet powder, hibiscus, cherries, cranberries, pomegranate juice, strawberries, tomatoes, and other red freeze-dried fruits. However, none of these options has been widely accepted due to the loss of color intensity or the inability to withstand the stresses imposed by light or heat, or the inability to withstand the pH ranges for processed foods. For example, the existing natural red colors (carmine, anthocyanins and betalains) quickly degrade and lose their red color at high temperatures.

It is generally understood that natural colors are sensitive to exposures to heat and light, and particularly vulnerable to the stresses of conventional manufacturing processes, including exposure to heat, mixing, sheer and pressure changes. The characteristics and physical profiles of many natural colors have resulted in substantial manufacturing challenges when food and beverage manufacturers attempt to replace the synthetic colorants, such as Red No. 3 and Red No. 40 dyes. Further still, consumer acceptance is of paramount importance, where acceptance often depends on replacing the synthetic dye with a natural colorant that will mimic the existing color profile of the food or beverage product without imparting any flavor or sensory changes.

Thus, there remains a long and unmet need for a natural, food-grade, red colorant that is simultaneously pH and heat stable. This unmet need has become increasingly urgent in view of restrictions limiting the long-term viability of artificial red food colorants. It is against this background that the inventors have unexpectedly identified novel compositions comprising natural ingredients that can provide a natural red color to food and beverages, and even more, capable of meeting the food industry's standards for a red colorant.

### SUMMARY OF THE INVENTION

The present invention relates to a natural, food-grade color composition that is a suitable alternative to artificial red food color for food products. In certain embodiments, the composition contains at least two polyphenols, wherein at least one polyphenol is a phenolic diterpene. In certain embodiments the composition contains at least one antioxidant and at least one catechin. According to at least one embodiment, the composition is a blend of rosemary extract and green tea extract. According to at least one embodiment, the composition and/or food product will have an absorption peak on the UV-vis spectrum between about 490 nm and about 570 nm.

One aspect of the present invention relates to providing a desired color to food products achieved by adding an ingredient that is derived from natural sources. Another aspect of the invention is to improve the redness of a food product. Another aspect of the invention is increasing redness, or alternatively the a-value, of a food product by adding an ingredient to the food product that is derived from natural sources. In certain embodiments, the ingredient is incorporated, or mixed, into the food product. In alternative embodiments, the ingredient is applied to a surface of the food product. Another aspect of the present invention relates to providing a natural red color to food products that is heat-resistant. Another aspect of the present invention relates to a natural red color that can withstand exposure to light, i.e., maintains a red color without protection from light. Another aspect of the present invention relates to a natural red color that maintains its color intensity even after prolonged exposure to heat and/or light. Another aspect of the invention relates to using a color blender to adjust the red color, which may comprise beet powder. Another aspect of the present invention relates to a natural red color that is suitable for pH ranges typical of foods.

### BRIEF DESCRIPTION OF THE FIGURES

FIG. 1 shows solutions of RGT with varying additives stored at room temperature.

FIG. 2 shows solutions of RGT with different amounts of sodium bicarbonate stored at room temperature.

FIG. 3 shows a solution of rosemary (non-soluble) adjusted to alkaline pH and stored for 24 hours at room temperature.

FIG. 4 shows a solution of green tea adjusted to alkaline pH and stored for 24 hours at room temperature.

FIG. 5 shows the color “a-values” of pH adjusted and unadjusted solutions of RGT 1200 WS.

FIG. 6 shows the red color “a-values” for Fortium RGT 1200 WS (alkaline) heated and non-heated solutions.

FIG. 7 shows the pea protein model system before heating.

FIG. 8 shows the pea protein model system after heating.

FIG. 9 shows propylene Glycol-FG,K after heating.

FIG. 10 shows glyceryl monooleate-FG,K after heating.

FIG. 11 shows green tea 45% EGCG-FG,K after heating.

FIG. 12 shows rosemary extract after heating.

FIG. 13 shows POE 20 sorbitan monooleate-FG,K after heating.

FIG. 14 shows rosemary extract/green tea blend after heating.

FIG. 15 shows the UV-vis spectrum of RE/GTE-derived color prepared under very mild conditions.

FIG. 16 shows a sample taken every hour during a heat treatment of RE/GTE 1/2.

FIG. 17 shows the UV-vis spectrum of RE/GTE-derived color (RE/GTE 1/2).

FIG. 18 shows the UV vis spectrum of samples (derived from RE/GTE 1/2) without quenching steps (cooling, filtration and pH4 adjustment). A1: no quenching steps, ambient storage; A2: no quenching steps, refrigerated storage.

FIG. 19 shows the UV vis spectrum of samples (derived from RE/GTE 1/2) with quenching steps (cooling, filtration and pH4 adjustment). C1: with quenching steps, ambient storage; C2: with quenching steps, refrigerated storage.

FIG. 20 shows a sample taken every hour during a heat treatment (RE/GTE 5/1).

FIG. 21 shows the UV-vis spectrum of RE/GTE-derived color (RE/GTE 5/1).

FIG. 22 shows the UV vis spectrum of samples (derived from RE/GTE 5/1) without quenching steps (cooling, filtration and pH4 adjustment). F1: no quenching steps, ambient storage; F2: no quenching steps, refrigerated storage.

FIG. 23 shows the UV vis spectrum of samples (derived from RE/GTE 5/1) with quenching steps (cooling, filtration and pH4 adjustment). I1: with quenching steps, ambient storage; I2: with quenching steps, refrigerated storage.

FIG. 24 shows RE/GTE-derived color formation (RE pre-solubilized in water) at 1, 2, and 2 hours.

FIG. 25 shows the UV-vis spectrum of RE/GTE-derived color (RE pre-solubilized in water).

FIG. 26 shows the UV-vis spectrum of RE/GTE-derived color at very low GTE dosage (RE/GTE 100/1).

FIG. 27 shows RE/GTE-derived color formation upon GTE addition.

FIG. 28 shows the UV-vis spectrum of RE/GTE-derived color formation upon GTE addition. Total 50 ml of GTE solution was added at 0.5 ml/10 min.

FIG. 29 shows the UV-vis spectrum of RE/GTE (2/1)-derived color development during the heat process. TO: initial; T3: 30 minutes; T5: 50 minutes; T7: 70 minutes; T9: 90 minutes; T12: 120 minutes; T16: 160 minutes; T19: 190 minutes.

FIG. 30 shows the UV-vis spectrum of RE/GTE-derived color development with fast GTE addition (one dosage added once). TO: initial; T1: 10 minutes; T2: 20 minutes; T4: 40 minutes; T7: 70 minutes; T8: 80 minutes.

FIG. 31 shows the UV-vis spectrum of RE/GTE-derived color development with slow GTE addition (one portion of ⅛ dosage every 10 minutes). TO: initial; T1: 10 minutes; T2: 20 minutes; T4: 40 minutes; T7: 70 minutes; T8: 80 minutes.

FIG. 32 shows spray-dried RE/GTE-derived red powder (right) and beet red powder (left).

FIG. 33 shows reconstituted solution of red beet and RE/GTE-derived red color in water at different concentrations.

FIG. 34 shows a reconstituted solution of red beet-derived red color before heating (left and after heating (right, 140° C. for 20 minutes).

FIG. 35 shows a reconstituted solution of RE/GTE-derived red color before heating (left and after heating (right, 140° C. for 20 minutes).

FIG. 36 shows reconstituted RE/GTE-derived red color at different pH levels.

FIG. 37 shows hard crack candy containing 0.2% of RE/GTE-derived red color from 3 different batches (RGR 2.1A, B and C).

FIG. 38 shows the Hunter L, a, b values for hard crack candy containing 0.2% of RE/GTE-derived red color from 3 different batches (RGR 2.1A, B and C).

FIG. 39 shows sugar icing containing 3% of RE/GTE-derived red color from 3 different batches (RGR 2.1A, B and C).

FIG. 40 shows the Hunter L, a, b values for sugar icing containing 3% of RE/GTE-derived red color from 3 different batches (RGR 2.1A, B and C).

FIG. 41 shows milk (mimicking strawberry milk) containing 0.05% of RE/GTE-derived red color from 3 different batches (RGR 2.1A, B and C).

FIG. 42 shows the Hunter L, a, b values for milk (mimicking strawberry milk) containing 0.05% of RE/GTE-derived red color from 3 different batches (RGR 2.1A, B and C).

FIG. 43 shows hard crack candy containing RE/GTE-derived color with and without citrate/ascorbate stabilizer on day 0 and day 8.

FIG. 44 shows RGR, beet alone, and blended solutions under sunlight exposure.

FIG. 45 shows the L* of RGR, beet alone, and RGR/beet blend solutions under direct sunlight exposure.

FIG. 46 shows the a* of RGR, beet alone, and RGR/beet blend solutions under direct sunlight exposure.

FIG. 47 shows the b* RGR, beet alone, and RGR/beet blend solutions under direct sunlight exposure.

FIG. 48 shows hard crack candy containing RGR, beet alone and RGR/beet blends under sunlight exposure.

FIG. 49 shows drop sugar cookies treated with 2% color (RGR, beet alone and RGR/beet blend).

FIG. 50 shows Jimmies sprinkles containing RGR, beet alone and RGR/beet blend.

FIG. 51 shows the pH stability of 0.2% solution of RGR alone.

FIG. 52 shows the pH stability of 0.2% solution of RGR/beet blend (65/35).

### DETAILED DESCRIPTION OF THE INVENTION

The present invention relates to a natural, food-grade color composition that is a suitable alternative to a synthetic or artificial colorant for food products. In certain embodiments, the composition contains at least two polyphenols, wherein at least one polyphenol is a phenolic diterpene. In certain embodiments the composition contains at least one antioxidant and at least one catechin. According to at least one embodiment, the composition is a blend of rosemary extract and green tea extract. One aspect of the present invention relates to a natural red color that is heat-resistant. By way of non-limiting example, in certain embodiments the red color is resistant to heat at about 212° F. for 20 minutes or more. In alternative embodiments, the red color is resistant to heat at temperatures greater than 212° F. In yet alternative embodiments, the red color is resistant to heat at temperatures greater than about 300° F. degrees, about 350° F. or about 400° F. In certain embodiments, the red color does not change even after prolonged exposure to heat, for instance up to three hours.

According to at least one embodiment, the composition and/or the food product will have an absorption peak on the UV-vis spectrum between about 490 nm and about 570 nm. In certain embodiments, the composition and/or the food product will have an absorption peak on the UV-vis spectrum at about 530 nm. In certain embodiments, when a peak at between about 490 nm and about 570 nm increases in intensity compared to the rest of the spectrum, this indicates an increase in redness. In certain embodiments, when a peak at about 530 nm increases compared to the rest of the spectrum, this indicates an increase in redness.

Another aspect of the present invention relates to a natural red color that can withstand exposure to light, i.e., maintains a red color without protection from light. According to at least one embodiment, the red color can withstand exposure to daylight for one month or more. In alternative embodiments, the red color can withstand exposure to daylight for three months or more. In certain embodiments, the red color can withstand exposure to artificial lighting for at least one month.

Another aspect of the present invention relates to a natural red color that maintains its color intensity even after prolonged exposure to heat or light. In certain embodiments, the red color maintains its intensity even after prolonged exposure, for instance that expected for the transportation, storage, and the typical shelf life of certain food products.

Another aspect of the present invention relates to a natural color that is suitable for pH ranges typical of foods. In certain embodiments, the natural red color is suitable for food products with a pH in the range of about 2.0 to about 10.0, about 4.0 to about 10.0, about 6.0 to about 10.0, about 6.0 to about 9.0, greater than about 6.0, and greater than about 8.0.

In certain embodiments the pH of the composition may be adjusted to any desired pH through the use of a pH adjuster. Any suitable pH adjuster may be used, including but not limited to sodium hydroxide, phosphate, or sodium bicarbonate. pH adjustment may occur during processing, wherein the pH adjuster is a processing aid that may or may not present in the final composition.

In certain embodiments, the composition contains an effective amount of rosemary extract and green tea extract. These solvents may be obtained through solvent extraction or supercritical extraction. Any suitable solvent may be used. In alternative embodiments, other polyphenols, antioxidants, or catechins can be used to achieve the desired effect. In alternative embodiments, a color blender may be used to adjust the color. This color blender may comprise beet powder. In certain embodiments, the beet powder may be obtained from drying and milling a beet. In certain embodiment, the beet powder may be obtained through extraction and drying. In alternative embodiments, the composition may optionally contain additional components suitable for a food product.

In certain embodiments, the ratio of rosemary extract to green tea extract may range from 1:1, 1:2, 5:1, 10:1, 100:1, or other ratios depending on the desired effect.

One aspect of the invention includes increasing the CIE a-value of a food product within the “L,a,b” system, where the “a-value” is an indicator of “redness”, the higher the value, the more red. In alternative embodiments, the color may be varying shades or red or caramel or other desired colors for food products.

In certain embodiments, indicators of “redness” can be used to assess desired outcomes. These indicators are known in the art. In certain embodiments, redness can be measured by L,a,b values, particularly the a-value. In certain embodiments, redness can be measured by UV-vis absorption.

In certain embodiments, the composition is a liquid. In certain embodiments, the colorant is water soluble. In alternative embodiments, the composition is a dry ingredient or powder.

In certain embodiments, the composition may optionally include antioxidants, metal chelators, pH regulators, encapsulation compounds, flavorings, and/or other excipients.

The following examples illustrate the present invention and are not intended to be limiting.

### EXAMPLES

### Example 1

Fortium™-RGT 1200 WS (Lot No. 224110068) (Kemin Industries, Des Moines, IA); Brifisol 512 Ettlinger Corp. (Lincolnshire, IL); Rosemary Extract MO17612 (Lot No. 2208117506), (Kemin Industries, Des Moines, IA); Green Tea (RM 16500 Extract 450) (Lot No. 2205118127), (Kemin Industries, Des Moines, IA).

The researchers were working on protypes of marinades using phosphate (Brifisol 2%), salt (1%) and Fortium RGT1200 WS (2%) for pink salmon, and surprisingly found that a deep red color developed when the mixture was allowed to set for 24 hours at room temperature. To determine what made the red color, samples were made in the amounts summarized in Table 1.

TABLE 1
Ingredients used in red color trials.

| | Amount (g) | Percentage |
|---|---|---|
| Ingredient #1 | | |
| Water | 980 | 95.1 |
| Fortium RGT 1200 WS | 20 | 1.9 |
| Salt | 10 | 1.0 |
| Brifisol | 20 | 1.9 |
| Total | 1030 | 100 |
| Ingredient #2 | | |
| Water | 980 | 98.0 |
| Fortium RGT 1200 WS | 20 | 2.0 |
| Salt | 0 | 0 |
| Brifisol | 0 | 0 |
| Total | 1000 | 100 |
| Ingredient #3 | | |
| Water | 980 | 97.0 |
| Fortium RGT 1200 WS | 20 | 2.0 |
| Salt | 10 | 1.0 |
| Brifisol | 0 | 0 |
| Total | 1010 | 100 |
| Ingredient #4 | | |
| Water | 980 | 96.1 |
| Fortium RGT 1200 WS | 20 | 2.0 |
| Salt | 0 | 0 |
| Brifisol | 20 | 2.0 |
| Total | 1020 | 100 |

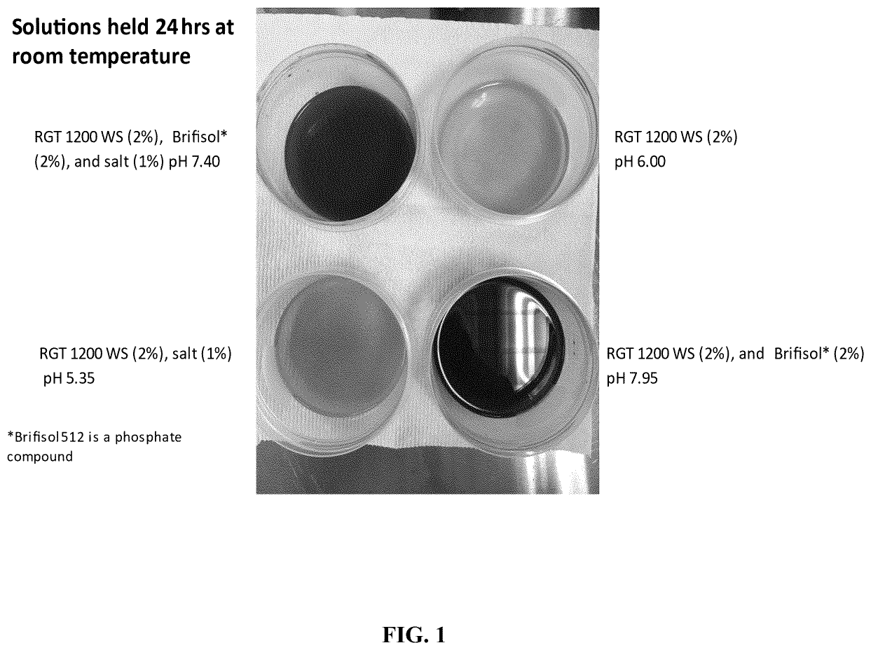

The samples were then let to set at room temperature for approximately 24 hours. The results showed that RGT1200 WS alone did not turn red, RGT1200 WS with salt, did not turn red, but both samples that contained RGT1200 WS and phosphate (Brifisol) turned red, as depicted in FIG. 1.

The researchers then considered whether it was Brifisol (a phosphate) that was specific to the red color or was it related to the pH. From FIG. 1, it was observed that the pH values from the samples with added phosphate with a pH at or above pH 7.4, compared to samples with no added phosphate with a pH between 5.35 and 6.0.

To understand this observation, the researchers next conducted an experiment using sodium carbonate and sodium bicarbonate as the base component of the antioxidant blends, replacing the phosphate Brifisol.

TABLE 2
Formulas using either sodium bicarbonate or carbonate.

| Ingredient | Amount (g) | Percentage |
|---|---|---|
| Water | 980 | 97.7 |
| Fortium RGT 1200 WS | 20 | 2.0 |
| Sodium carbonate (pH 8.6) | 3.4 | 0.34 |
| Total | 1003.4 | 100 |
| Water | 980 | 97.4 |
| Fortium RGT 1200 WS | 20 | 2.0 |
| Sodium bicarbonate (pH 7.74) | 5.9 | 0.59 |
| Total | 1005.9 | 100 |

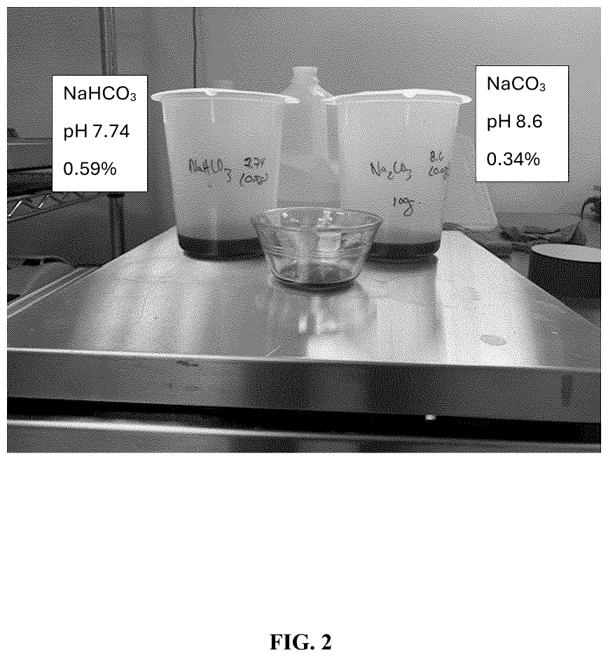

Both samples turned a bright red after 24 hours as shown in FIG. 2. This suggests that the color development is pH related, and not phosphate dependent.

The researchers conducted further testing to determine what component in Fortium RGT 1200 WS was potentially responsible for the red color development. The two main components that make up RGT 1200 WS are Rosemary Extract (non-soluble), and Green Tea RM16500 GT Extract 450. The samples were made according to Table 3.

TABLE 3
Mixtures containing either rosemary or green tea ingredients.

| Ingredient | Amount (g) | Percentage |
|---|---|---|
| Rosemary Extract | 20 | 2 |
| Sodium Bicarbonate (pH 7.8) | 2.9 | 0.03 |
| Water | 980 | 97.7 |
| Total | 1002.9 | 100 |
| Green Tea RM 16500 Extract 450 | 20 | 2 |
| Water | 980 | 98 |
| Sodium Bicarbonate (pH 7.8) | 3.9 | 0.4 |
| Total | 1003.9 | 100 |

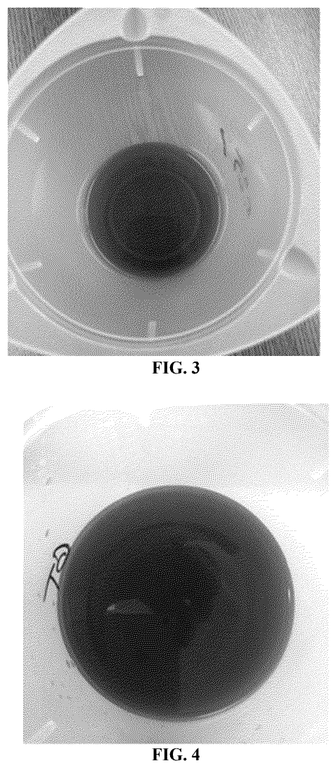

The pH adjusted mixtures were stored at room temperature. After 24 hours neither of the individual components developed a red color, as depicted in FIGS. 3 and 4. Thus, it became apparent that the red color development was due to the combination, or synergy, when both components were combined to produce a red pigment.

### Example 2

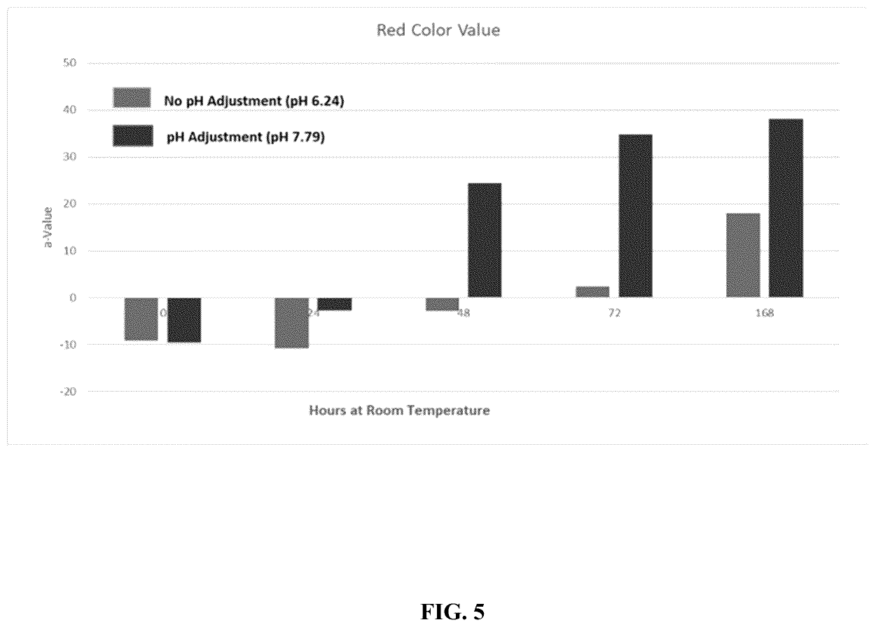

In order to obtain results in a readable range during red color development, the researchers placed 25 ml into a 4-inch dia. Petrie dish and set the dish upon a Photomyne, Model A4-2,0 light table (center). The color in the plate was read with a NIX Pro Color meter (NIX Sensor Ltd., Hamilton ON) set in direct contact with surface (Illuminant D50, Observer) 2° (see FIG. 4). Formulas for the solutions measured can be seen in Table 4. The CIE “a-value” was recorded as an indicator of the red hue. Results for the color a-values are summarized in Table 5 and FIG. 5.

TABLE 4
Formulas for pH adjusted and unadjusted solutions.

| Ingredient | Amount (g) | Percentage |
|---|---|---|
| Control Non pH Adjustment (pH 6.2) | | |
| Water (tap) | 980.0 | 98.0 |
| Fortium RGT 1200 WS | 20.0 | 2.0 |
| Total | 1000.0 | 100 |
| pH Adjustment (pH 7.79) | | |
| Water (tap) | 980.0 | 97.6 |
| Fortium RGT 1200 WS | 20.0 | 2.0 |
| Sodium bicarbonate | 4.0 | 0.4 |
| Total | 1004.0 | 100 |

TABLE 5
Color “a-values” for pH adjusted and
unadjusted solutions of RGT 1200 WS.
“a-value”

| Hours | Control Non pH Adjustment (pH 6.2) | pH Adjustment (pH 7.8) |
|---|---|---|
| 0 | −9.2 | −9.6 |
| 24 | −10.8 | −2.7 |
| 48 | −2.9 | 24.3 |
| 72 | 2.3 | 34.7 |
| 168 | 18.0 | 38.1 |

Samples were stored in 1000 ml plastic beakers at room temperature. (n = 1)

### Example 3

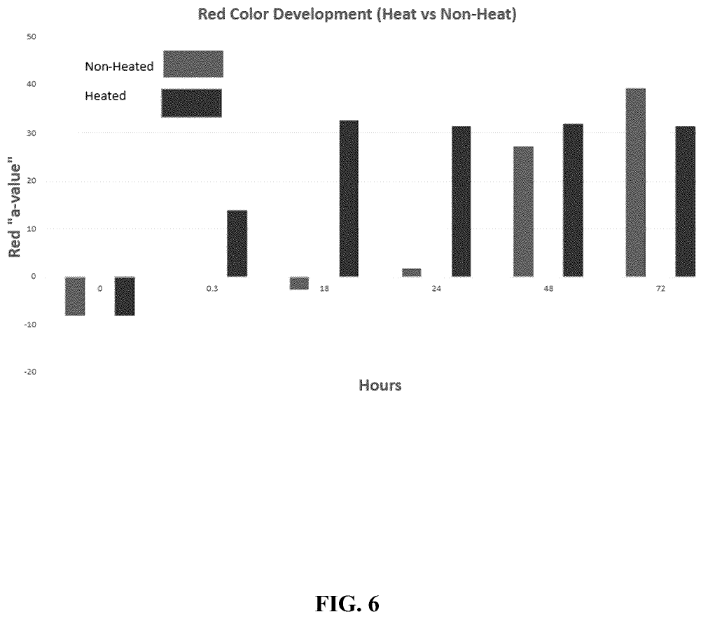

To determine if the development of red color was affected by heat, a single batch of Fortium-RGT 1200 WS (Lot #224110068) was mixed according to the formula described in Table 6. The batch was split in half, with one half as an unheated control and the other half heated samples. For the heated samples, aliquots (30 ml) of product were placed into a 50 ml plastic centrifuge tubes and placed into boiling water. Samples were periodically checked for temperature with a Thermapen (Utah-USA) thermometer. A final temperature between 195-197° F. was attained. After 20 minutes samples were set at room temperature and followed (a-value) over 72-hour storage. These a-values are summarized in Table 7 and FIG. 6.

TABLE 6
Formula for Alkaline adjusted Fortium ™-RGT 1200 WS

| Ingredient | Amount (g) | Percentage |
|---|---|---|
| Water (tap) | 392.0 | 96.4 |
| Fortium RGT 1200 WS | 8.0 | 2.0 |
| Sodium bicarbonate | 6.5 | 1.6 |
| Total | 406.5 | 100 |

TABLE 7
Color “a-values” for Fortium ™-RGT 1200 WS solutions
(2%) heated and stored at room temperature.

| Hours | 0 | 0.3 | 18 | 24 | 48 | 72 |
|---|---|---|---|---|---|---|
| Heated | | | | | | |
| | −8.2 | 15.2 | 41.3 | 36.8 | 30.6 | 30.4 |
| | −7.9 | 15.4 | 25.6 | 28.4 | 26.5 | 31.5 |
| “a-value” | −8.5 | 13.9 | 28.0 | 33.9 | 33.6 | 25.0 |
| | −8.2 | 13.9 | 30.8 | 25.2 | 38.4 | 34.3 |
| | −7.5 | 11.1 | 38.0 | 32.4 | 33.8 | 36.0 |
| AVE. | −8.06 | 13.9 | 32.74 | 31.34 | 32.58 | 31.44 |
| SD | 0.34 | 1.53 | 5.97 | 4.09 | 3.93 | 3.78 |
| No Heat | | | | | | |
| | −8.2 | — | −4.3 | 1.2 | 24.8 | 34.9 |
| | −7.9 | — | −1.9 | 2.6 | 21.7 | 42.2 |
| “a-value” | −8.5 | — | −0.8 | 0.4 | 28.2 | 40.0 |
| | −8.2 | — | −2.5 | 3.9 | 31 | 40.2 |
| | −7.5 | — | −3.4 | 0.9 | 30.1 | 38.9 |
| Ave. | −8.06 | — | −2.58 | 1.8 | 27.16 | 39.24 |
| SD | 0.34 | — | 1.21 | 1.28 | 3.46 | 2.42 |

### Example 4

To determine if the red color was compatible with food-style products, the researcher prepared a pea protein isolate as the meat block. Fortium™ RGT 1200 WS (2% w/w, water) was adjusted to pH 7.8 using sodium bicarbonate and allowed to turn red color and was added to the model system formula in Table 8. Fortium™ RGT 1200 WS (Lot #224110068), Textured Pea Protein (70%) (TPP™), Puris, Turtle Lake WI (Lot #200730ZB1); methyl cellulose, Pure Supplement Co., Lindon, UT).

TABLE 8
Formula for pea protein model system.

| Ingredient | Weight (g) |
|---|---|
| Fortium ™ RGT 1200 WS Alkaline (2% solution) | 9.2 |
| Texturized Pea Protein | 2.0 |
| Salt | 0.08 |
| Methyl cellulose | 0.26 |

In a 50 mL tube, water and color were added and mixed well. The textured pea protein was added and shaken and/or vortexed to mix well. The TPP was then soaked at room temperature for 15 minutes. After soaking, salt and methyl cellulose were added and mixed thoroughly with a spatula. The methyl cellulose expands and gels to bind the water and TPP. The mixed product was heating in a boiling water bath to a temperature of 167° F.

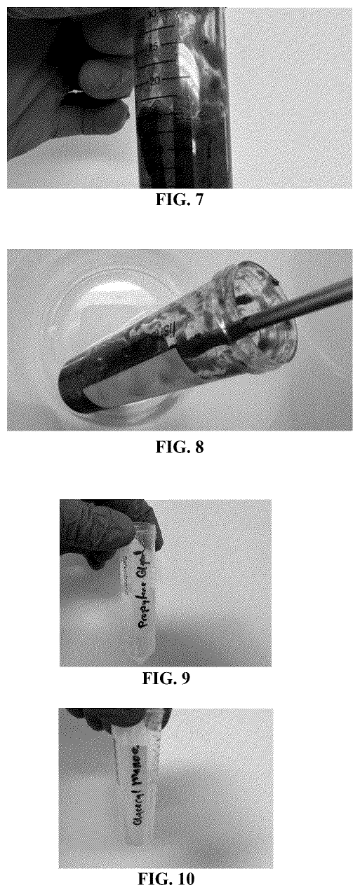

As shown in FIGS. 7 and 8, it was observed that heating to 167° F. did not seem to affect the red color from a visual standpoint.

### Example 5

Fortium™-RGT1200 WS is manufactured using numerous ingredients, which includes propylene glycol, glyceryl monooleate, green tea, rosemary and POE 20 sorbitan monooleate. To determine the role each ingredient played in the red color development, the components were examined separately.

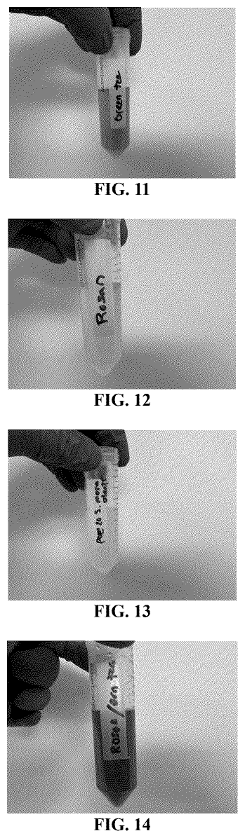

The individual components were mixed with cold tap water at a concentration equal to what would be found in a 2% solution and mixed using a Kitchen-Aid hand mixer. The pH was adjusted using sodium bicarbonate (anhydrous) until pH values of approximately 7.6 were achieved. The mixtures were placed into a 50 ml polypropylene centrifuge tubes and placed into boiling water while mixing until a temperature of 191° F. was achieved. The tubes were allowed cool for approximately 5 minutes and photographed (see FIGS. 9-14) and assessed for color using a method developed by placing 25 ml into a 4-inch dia. Petrie dish and setting the dish upon a Photomyne, Model A4-2,0 light table (center). The color in the plates were read with a NIX Pro Color meter (NIX Sensor Ltd., Hamilton ON) set in direct contact with surface (Illuminant D50, Observer) 2°.

The formulas for each separate batch are summarized in Table 9, and the a-values for the individual components are summarized in Table 10.

TABLE 9
Formulas for the evaluation of individual components
of Fortium ™-RGT1200WS

| | Ingredient | Amount (g) |
|---|---|---|
| Batch #1 | Rosemary ExtractM017612 | 1.25 |
| | Lot#2208117506 | |
| | Water | 498.75 |
| | Sodium bicarbonate | 19.09 (pH 7.59) |
| | Total | 519.09 |
| Batch #2 | Green Tea 45% EGCG-FG, K | 0.4 |
| | RM 16500 Lot#2205118127 | |
| | Water | 499.60 |
| | Sodium bicarbonate | 14.13 (pH 7.59) |
| | Total | 514.13 |
| Batch #3 | POE 20 Sorbitan Monooleate- | 4.9 |
| | FG, K | |
| | RM 15622 Lot# 2306113656 | |
| | Water | 495.1 |
| | Sodium bicarbonate | 10.86 (pH 7.58) |
| | Total | 510.86 |
| Batch #4 | Glyceryl Monooleate-FG, K | 0.8 |
| | RM 15384 Lot # 2206105153 | |
| | Water | 499.2 |
| | Sodium bicarbonate | 38.06 (pH 7.52) |
| | Total | 538.06 |
| Batch #5 | Propylene glycol-FG, K | 2.65 |
| | RM 1309 Lot# 2305114508 | |
| | Water | 497.4 |
| | Sodium bicarbonate | 19.83 (pH 7.57) |
| | Total | 519.88 |
| Batch # 6 | Green tea/Rosemary Combined | |
| | Rosemary ExtractM017612 | 1.25 |
| | Lot#2208117506 | |
| | Green tea 45% EGCG-FG, K | 0.4 |
| | RM 16500 Lot#2205118127 | |
| | Water | 498.35 |
| | Sodium bicarbonate | 59.07 (pH 7.58) |
| | Total | 559.07 |

TABLE 10
CIE color “a-values” of individual components
and descriptive color after heating.

| Individual Component | Average a-value* | Color |
|---|---|---|
| Rosemary ExtractM017612 | −4.5 | Slight yellow |
| Lot#2208117506 | | |
| Green Tea 45% EGCG-FG, K | 1.5 | Slight orange/brown |
| RM 16500 Lot#2205118127 | | |
| POE 20 Sorbitan Monooleate- | −6.9 | Clear |
| FG, K | | |
| RM 15622 Lot# 2306113656 | | |
| Glyceryl Monooleate-FG, K | −7.7 | Clear |
| RM 15384 Lot # 2206105153 | | |
| Propylene glycol-FG, K | −8.2 | Clear |
| RM 1309 Lot# 2305114508 | | |
| Rosemary ExtractM017612 | 22.2 | Red |
| Lot#2208117506 | | |
| Green tea 45% EGCG- | | |
| FG, K | | |
| RM 16500 | | |
| Lot#2205118127 | | |

*Average of 3 readings; The “a-value” is an indicator of “redness”, the higher the value, the more red.

Importantly, the researchers found that the blending of green tea and rosemary was crucial for the development of a desirable red color. The emulsifiers did not appear to participate in the red color reactions, nor did green tea or rosemary when examined separately.

### Example 6

Data suggests that the red colors developed from Fortium™-RGT1200WS at alkaline pH's was caused by the mixing of two components, green tea, and rosemary. Separately, there is no red color development. Polyphenols are found to be the components most often responsible for a product's color with anthocyanins being the causative agent in wines, grapes, apple skins, etc., but there are no anthocyanins found in green tea (Abdel-Aal, et al, 2022;). Zeng (2017) found that catechins account for 30-42% of the dry weight solids in green tea. The major catechins found in green tea are (−)epigallocatechin-3-gallate (EGCG) or its closely aligned derivatives, epicatechin gallate (ECG), epigallocatechin (EGC), and epicatechin (EC). The polyphenolic profile of rosemary is carnosic acid, carnosol, rosmarinic acid, and hesperidin (Nieto et al, 2018). No mention of anthocyanins as a component. Rosemary has been shown to be an effective antioxidant (Cuvelier, et al, 1996).

Wang (2022) focused on the compound EGCG and suggested that it is the main component in green tea responsible for color and taste. He also stated that it is highly prone to degradation and epimerization during processing. Examining EGCG under varying conditions he found increases in rate constants followed increases in temperature and pH. He also reported increases in “a-values” with increase in temperature or pH. Zimeri et al (1999) found that tea polyphenols, EGCG being the main component, degraded faster with increase in temperature or pH. Hong et al 2002 examining effects of temperature and pH stated that the stability of EGCG was most affected by pH. Wang (2022) describes the oxidation products of EGCG as being tan in color or pale yellow (not red). This is similar to the yellow/brown color that developed when we heated alkaline, green tea by itself.

The data suggests that a combination of green tea and rosemary, at alkaline pH is required to produce a bright red color. The researchers observed that the reaction rate increased as the temperature increased, and an alkaline pH is a requirement. One possible scenario for the development of red color is that EGCG, which is prone to oxidation, is stabilized by the antioxidant properties of the rosemary component. A potential oxidative pathway leading to a color change is blocked and instead the unoxidized EGCG compound combines with other compounds to produce a unique red color. A spectral analysis of EGCG should detect shifts or non-shifts indicating oxidative changes.

### Example 7

RE and GTE powder (1/2) were added to ethanol/water (70/30) at a total concentration of 0.25% and the pH adjusted to 6 with NaOH. The mixture was heated at 30° C. under stirring for 24 hours. A sample of the mixture was taken at beginning, 1 hour and 24 hours for UV-vis scan.

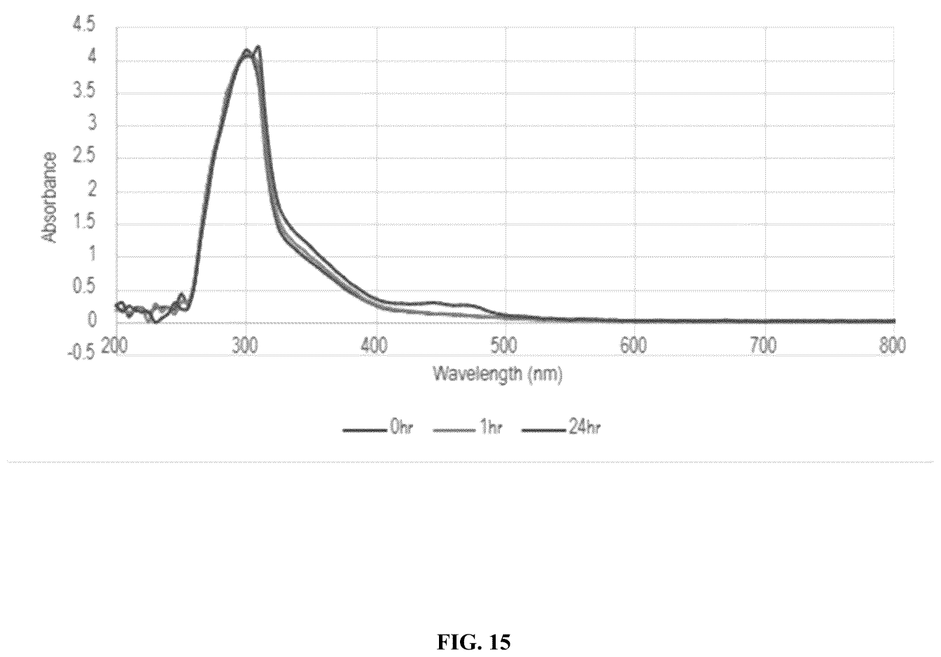

When examined visually, no obvious red color was observed. There are no significant peaks at 500-600 nm range in the UV-vis spectrum (FIG. 15) as indicator of red color. It is suggested that very mild conditions such as slightly acidic pH and gentle heat (slightly above room temperature) did not favor red color formation.

### Example 8

RE and GTE powders were added to water at different ratios (1/2 and 5/1) at a total concentration of 0.25% and the pH was adjusted to 7.5 with NaOH. The mixture was heated at 80° C. under stirring for up to 6 hours with sample taken for UV-vis scan every hour. Upon termination of the heat treatment, the mixture was cooled in refrigerator, filtered with filter paper and adjusted to pH4 with citric acid.

### RE/GTE at 1/2:

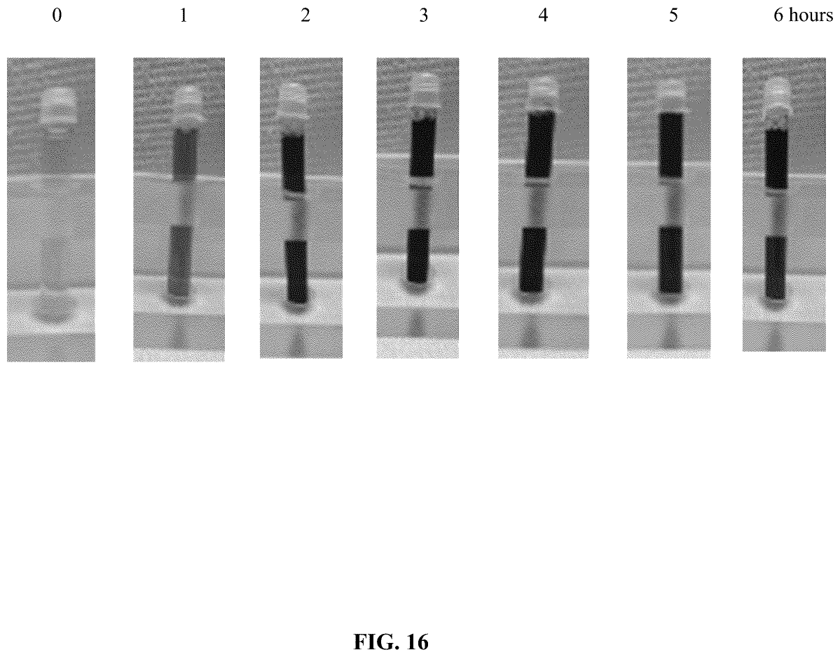

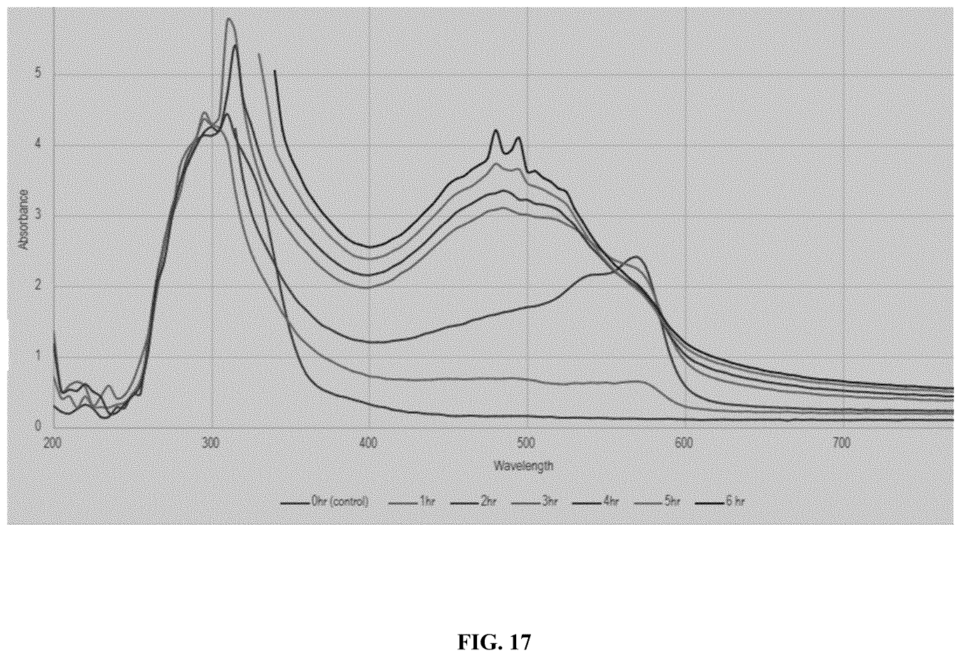

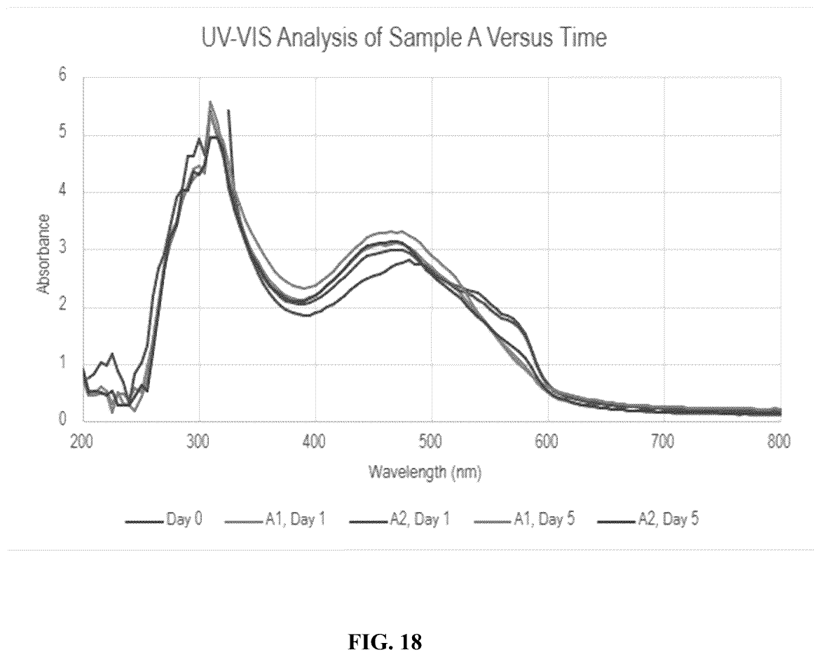

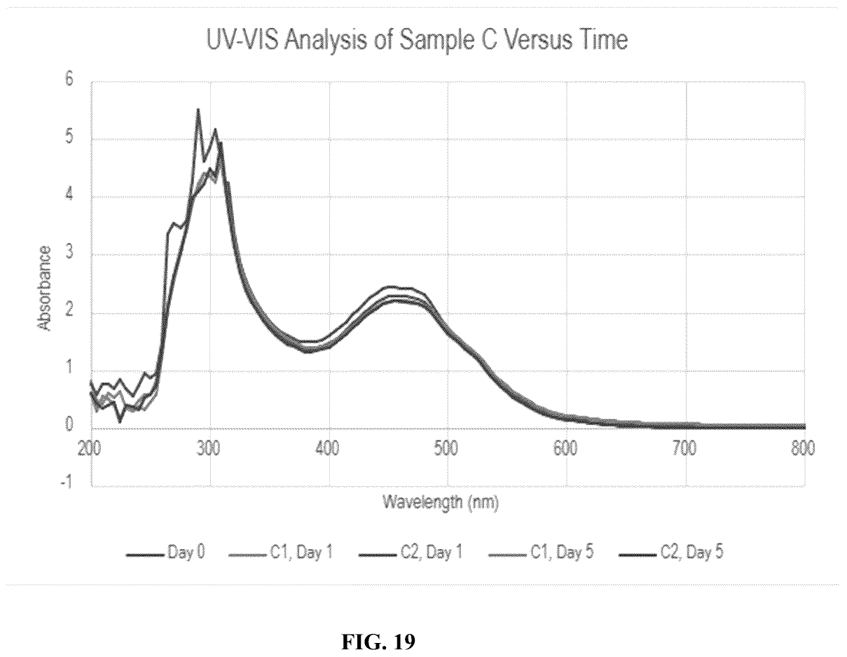

At RE/GTE ratio of 1/2, the mixture showed increased intensity of red over time and more warm tone (orange/red) towards the end (FIG. 16). UV-vis spectrum (FIG. 17) showed that the peak at 530/570 nm (red) dominated for the first 2 hours and shifted to 490 nm (orange) after, suggesting a critical time for best red color development to avoid under- and over-development of color. When quenching steps (cooling, filtration and pH4 adjustment) were taken, the color had better stability during storage compared to the mixture without quenching steps, as indicated by the UV vis spectrum (FIGS. 18-19).

### RE/GTE at 5/1:

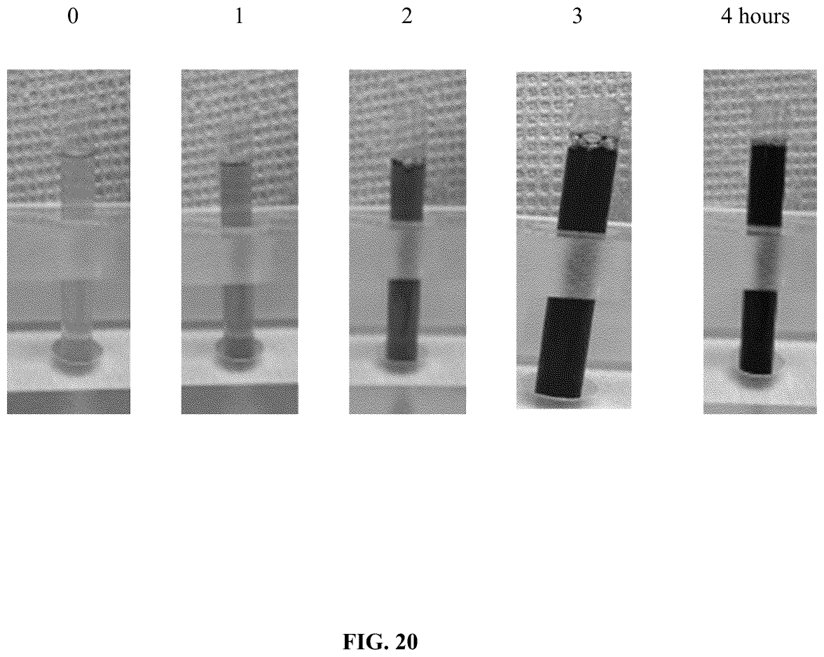

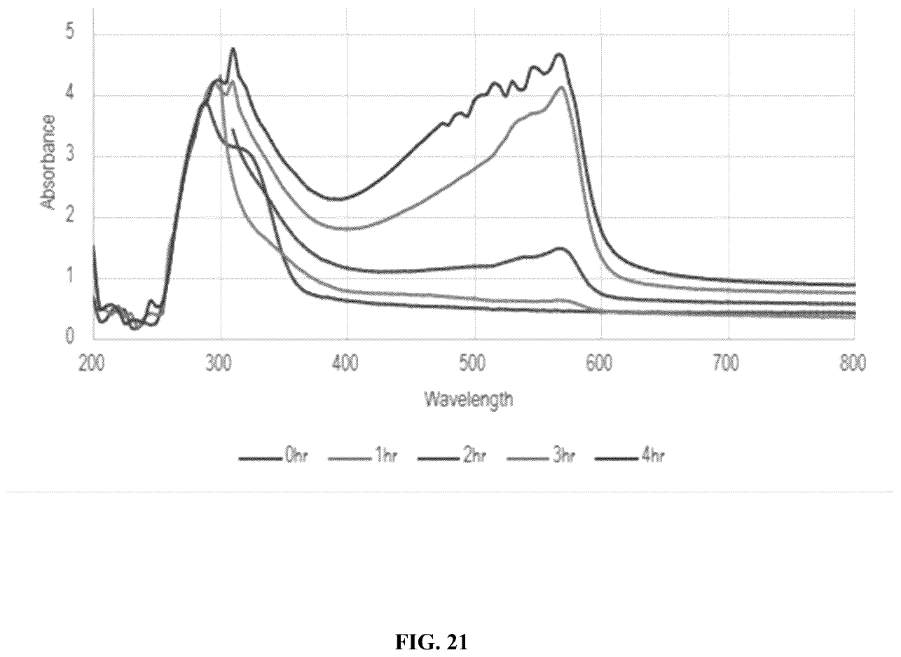

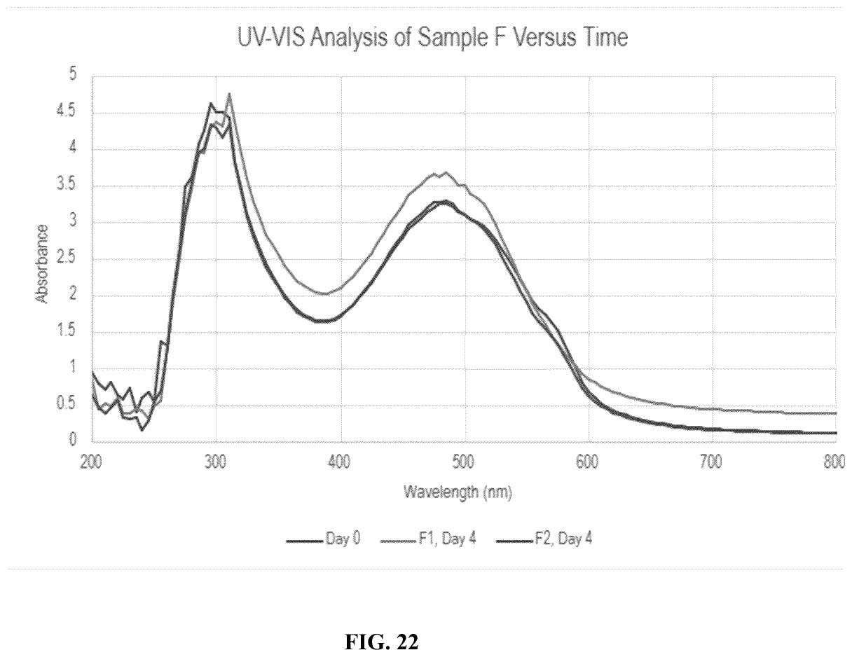

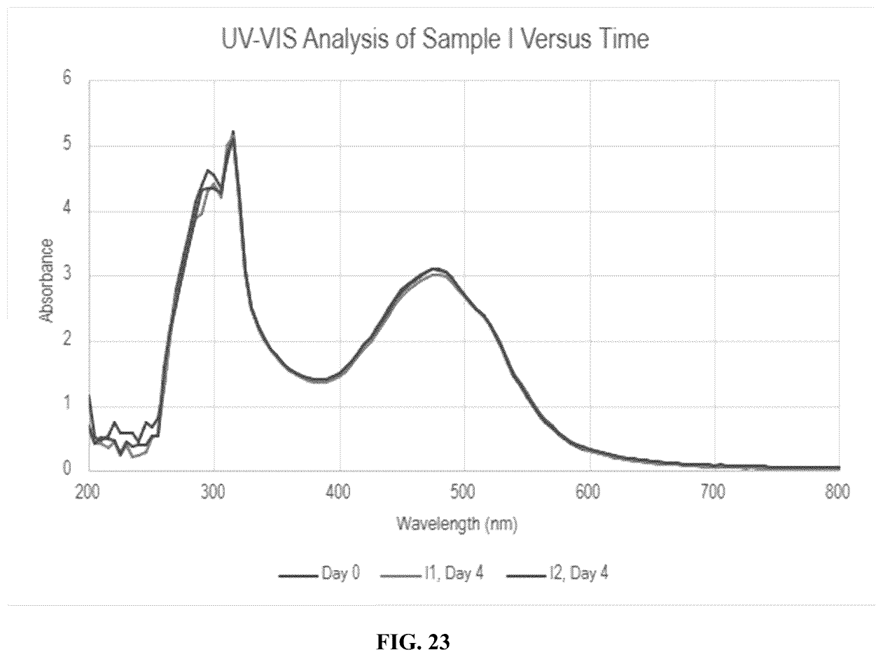

At RE/GTE ratio of 5/1, the mixture showed increased red intensity over time and did not shift to orange for 4 hours towards end of the heat treatment (FIG. 20). Red peaks (530 nm and 570 nm) dominated without significant peaks at 490 nm (orange) (FIG. 21). Compared to color prepared with RE/GTE at 1/2, a higher proportion of RE seems to be favorable for red color formation. Consistently, quenching steps (cooling, filtration, pH4 adjustment) helped stabilize the color during storage, especially under ambient storage (FIG. 22-23).

### Example 9

RE powder was pre-solubilized in water under alkaline pH (9.7) and heat before addition of GTE. Upon addition of GTE (RE/GTE 1/2, total concentration 0.25%), pH dropped significantly and was adjusted to pH7.5 with NaOH. The mixture was heated at 80° C. for 2 hours.

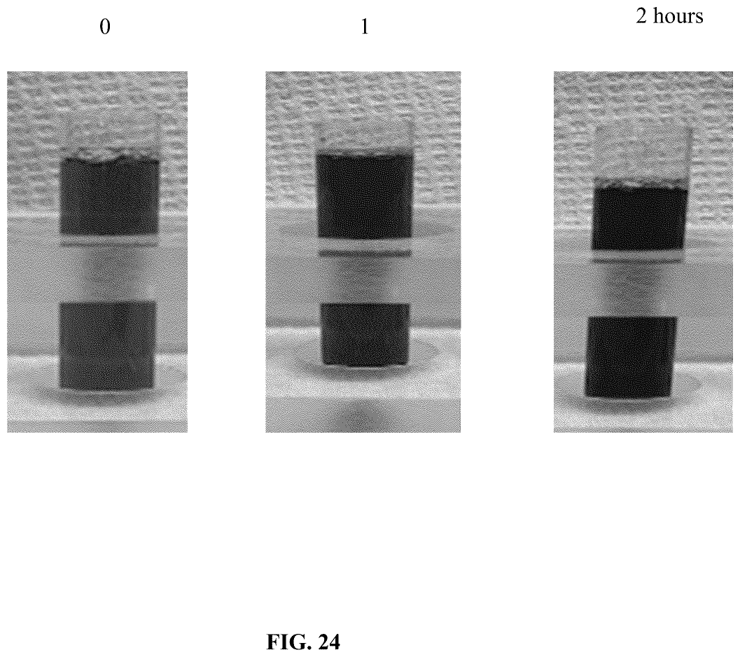

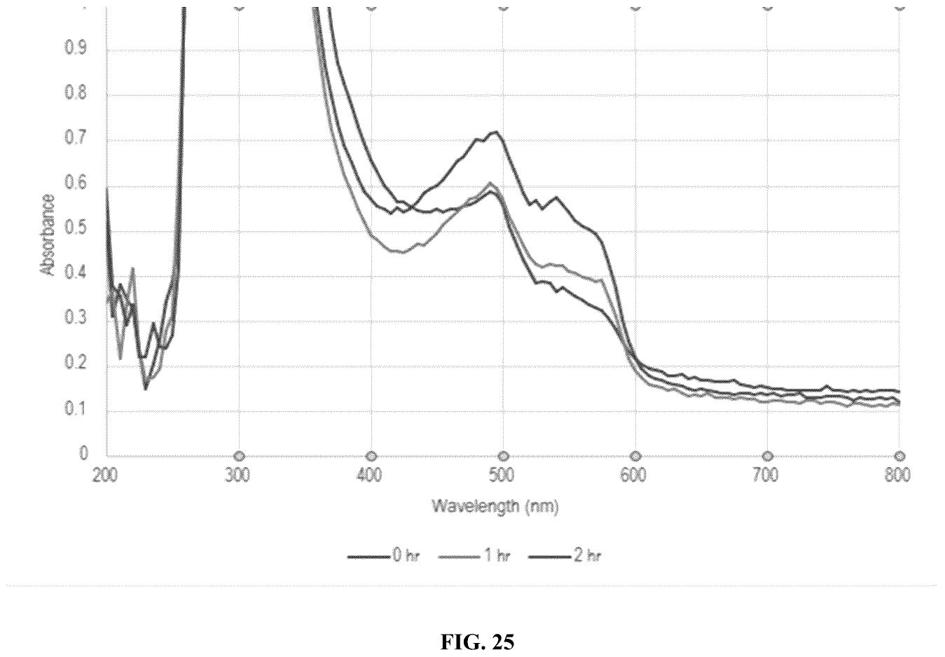

The color developed was more towards orange/amber than red (FIG. 24). The UV vis spectrum (FIG. 25) also confirms immediate formation of orange color indicated by a dominant peak at 490 nm over 530/570 nm. Continued RE supply seems to be important to prevent color shift from orange, as immediate availability and consumption of RE may lead to formation of orange color.

### Example 10

RE powder was pre-solubilized in water under alkaline pH (9.7) and heat before addition of GTE. GTE was added at a RE/GTE ratio of 100/1. The mixture was heated at 70° C. for 4 hours and allowed to stand for 4 days at ambient temperature to allow color development.

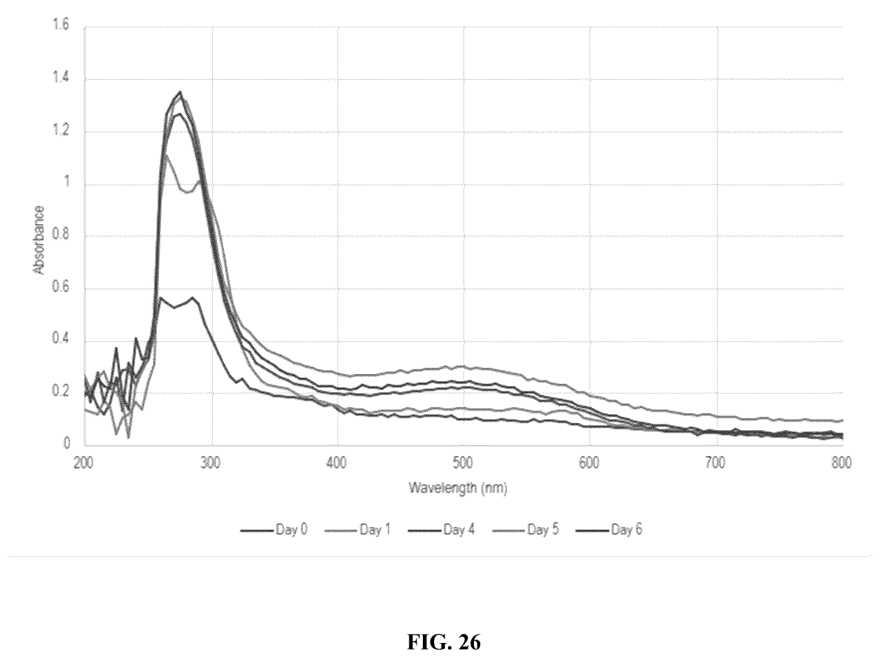

At an extremely high ratio of RE/GTE (100/1), there was no clear sign of red color formation even after a long heating and standing time. There are no significant peaks in the red region on the UV vis spectrum (FIG. 26). This suggests that GTE was actively participating in the color formation beyond a mediator role.

### Example 11

RE powder was pre-solubilized in water under alkaline pH (9.7) and heat before addition of GTE. GTE powder was dissolved in a small volume of water and added to the RE solution slowly (1% total dosage every 10 minutes, total RE/GTE 1/1, total concentration 0.25%). Mixture was heated at 70° C. and samples were taken upon every GTE dose added after allowing 10 minutes of mixing for UV vis scan.

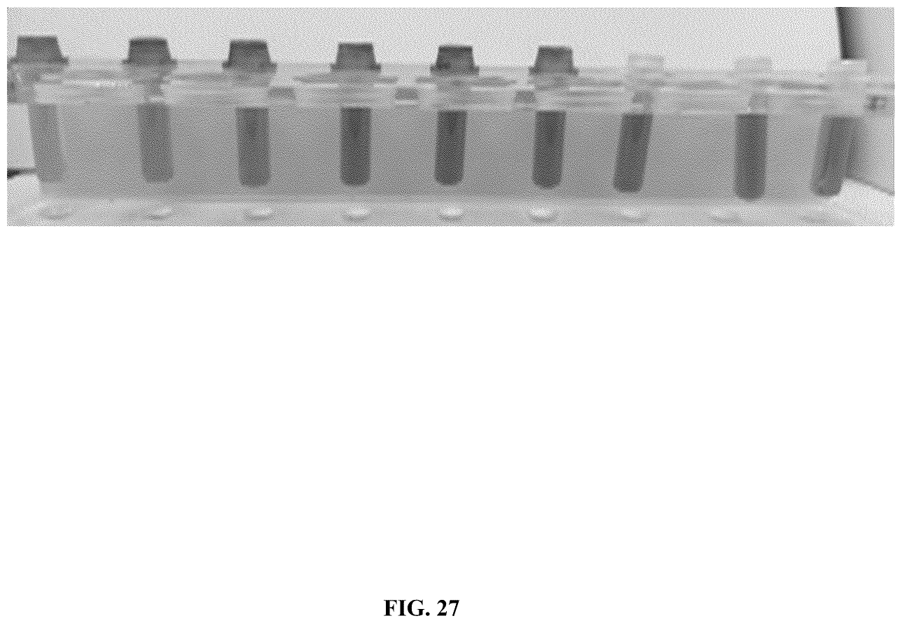

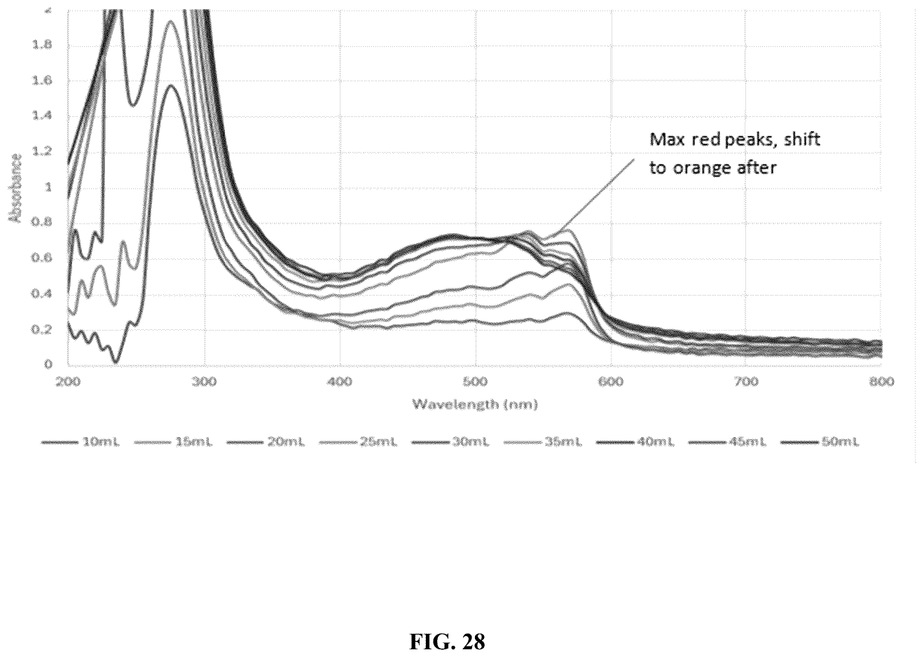

Red intensity increased upon GTE addition and reached maximum (indicated by absorbance at 530 nm/570 nm) at 50% of total GTE before shifting to orange (490 nm) (FIGS. 27 and 28). This suggests that RE/GTE at 2/1 might be a good ratio for achieving best red intensity with minimum orange interference.

### Example 12

RE powder was pre-solubilized in water under alkaline pH (9.7) and heat before addition of GTE (RE/GTE 2/1, total concentration of 0.25%). Addition of GTE significantly drops the pH around neutral. The mixture was heated at 70° C. and samples were taken for UV vis scan every 10 minutes for 190 minutes.

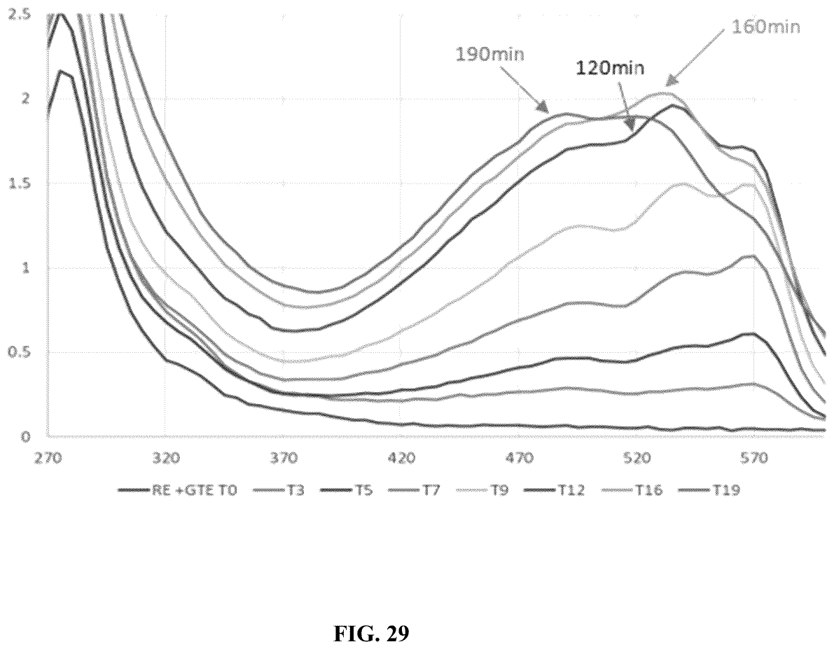

Color development followed a trend of violet-red (570 nm), red (530 nm), and orange (490 nm), as evidenced by visual examination and UV-vis spectrum (FIG. 29). Between 120-160 minutes, the mixture showed maximum red (530 nm) and relatively less violet-red and orange. After 160 minutes (e.g. 190 min), red began to decline coupled with increasing orange (490 nm). The heat treatment needs to be terminated at a certain time with desired violet-red/red/orange balance.

### Example 13

RE powder was pre-solubilized in water under alkaline pH (9.7) and heat before addition of GTE (RE/GTE 2/1, total concentration of 0.5%). GTE was pre-dissolved in a small volume of water and the aqueous GTE solution was added in two different ways: fast addition (whole dosage added once) and slow addition (a portion of ⅛ dosage every 10 minutes). The mixture was heated at 70° C. and samples were taken for UV vis scan every 10 minutes for 80 minutes.

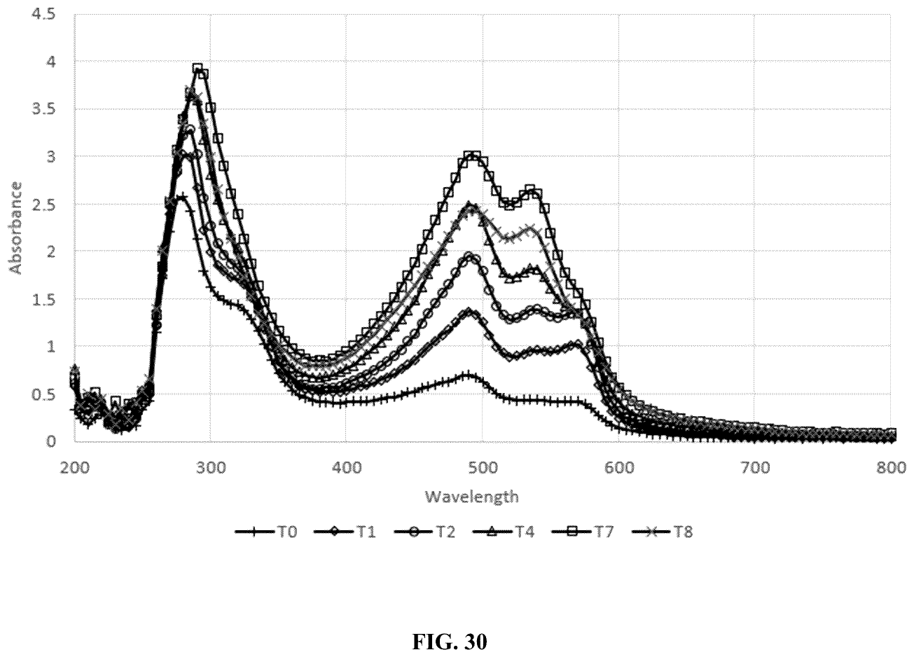

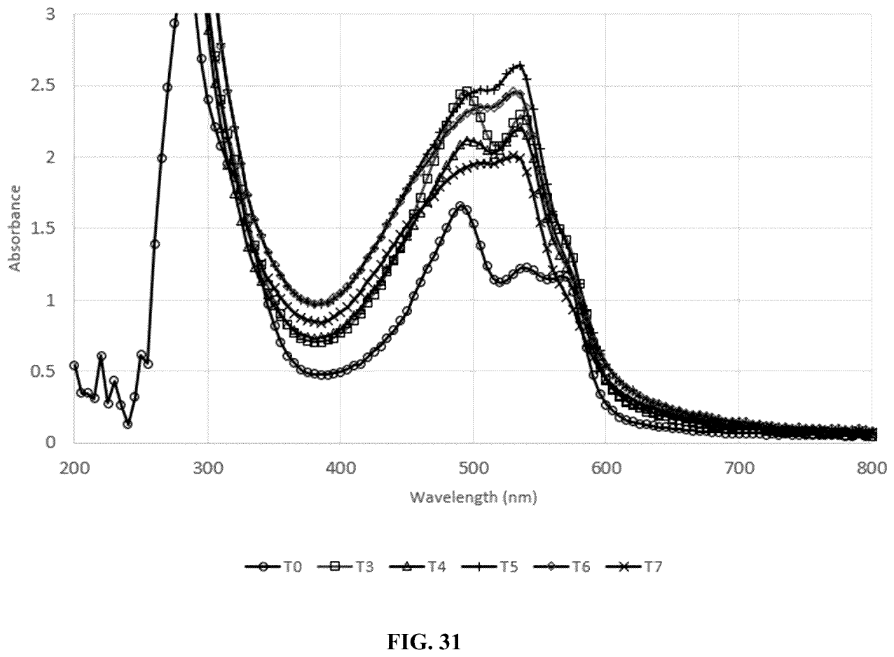

A high intensity red color was observed during the process. However, there was a clear difference between the two methods of addition for GTE. The fast addition of GTE resulted in a higher peak at 490 nm (orange) than 530 nm (red), whereas the slow addition of GTE resulted in the opposite, i.e. higher peak at 530 nm (red) than 490 nm (orange) (FIGS. 30 and 31). Therefore, slow GTE addition is a preferred method of addition for targeting maximum red and minimum orange. With both GTE addition methods, both red and orange peaks decreased after reaching maximum heights, confirming a critical time to terminate the process for optimal red intensity.

### Example 14

RE powder was pre-solubilized in water under alkaline pH (9.7) and heat before addition of GTE (RE/GTE 2/1, total concentration of 0.5%). GTE was pre-dissolved in a small volume of water and the aqueous GTE solution was added slowly (a portion of ⅛ dosage every 10 minutes). The mixture was heated at 70° C. till it reached a desired absorbance at 530 nm (around 70 minutes). The mixture was centrifuged to remove remaining RE. Potato maltodextrin was added as a spray-drying aid and color carrier. The solution was spray-dried with a benchtop spray drying unit to yield a red powder.

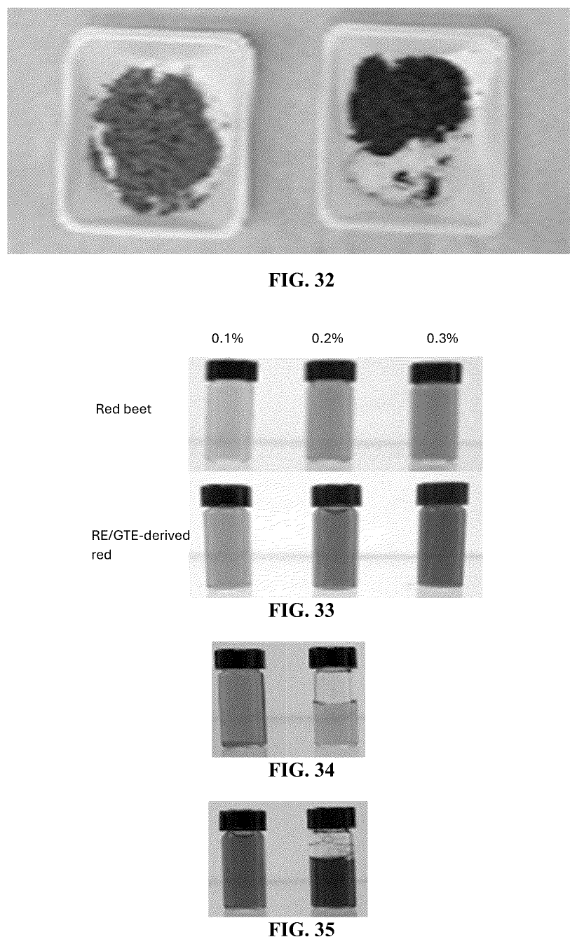

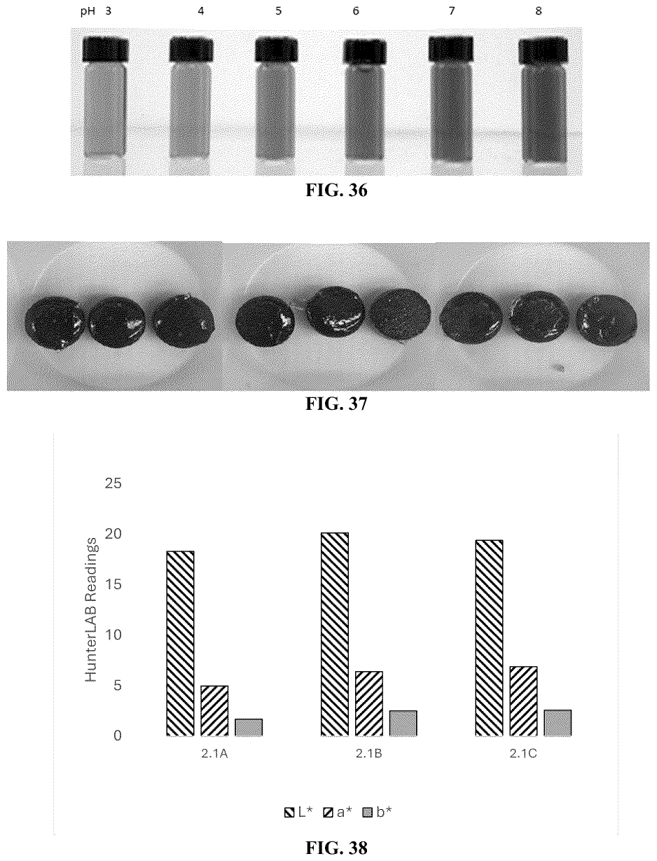

The spray-drying of the RE/GTE-derived color solution (with maltodextrin) carrier yielded a red free-flowing fine powder (FIG. 32). When reconstituted in water at 0.2%, it produced a more vibrant and true red color than beet color at the same concentration (FIG. 33). The RE/GTE-derived color had better heat-stability than beet after heating at 140° C. for 20 minutes (FIGS. 34-35). The RE/GTE-derived color was pH-dependent and turned towards warmer tone as pH decreases (FIG. 36). At pH6 and higher, it appeared a true red which shifted to orange at pH4-5 and eventually to yellow at pH3.

### Example 15

Three batches (RGR 2.1A, RGR 2.1B and RGR 2.1C) of the spray-dried powder of RE/GTE-derived red color (prepared according to Example 14) were evaluated in several food applications, including hard crack candy, icing and strawberry milk. Their color was measured as Hunter L, a, b.

TABLE 11
Recipe of hard crack candy.

| Ingredient | Ingredient % |
|---|---|
| Granulated White Sugar | 68.6 |
| Light Corn Syrup | 25.8 |
| DI Water #2 | 4.4 |
| RE/GTE-derived color | 0.2 |
| DI Water #1 | 1 |
| Total | 100 |

Preparation: In a small container, mix RE/GTE-derived color and DI water #1 together to create a liquid food color. Heat sugar mixture to 120° C. with constant stirring, then allow sugar syrup to heat to 150° C. with minimal stirring. Remove the sugar syrup from the heat and immediately mix in liquid food color, and pour into silicon molds.

TABLE 12
Recipe of icing.

| Ingredient | Ingredient % |
|---|---|
| Powdered White Sugar | 80.8 |
| DI Water | 18.0 |
| RE/GTE-derived color | 1.2 |
| Total | 100 |

Preparation: Combine powdered white sugar and RE/GTE-derived color together. Add water to dry ingredients and mix thoroughly to create sugar icing.

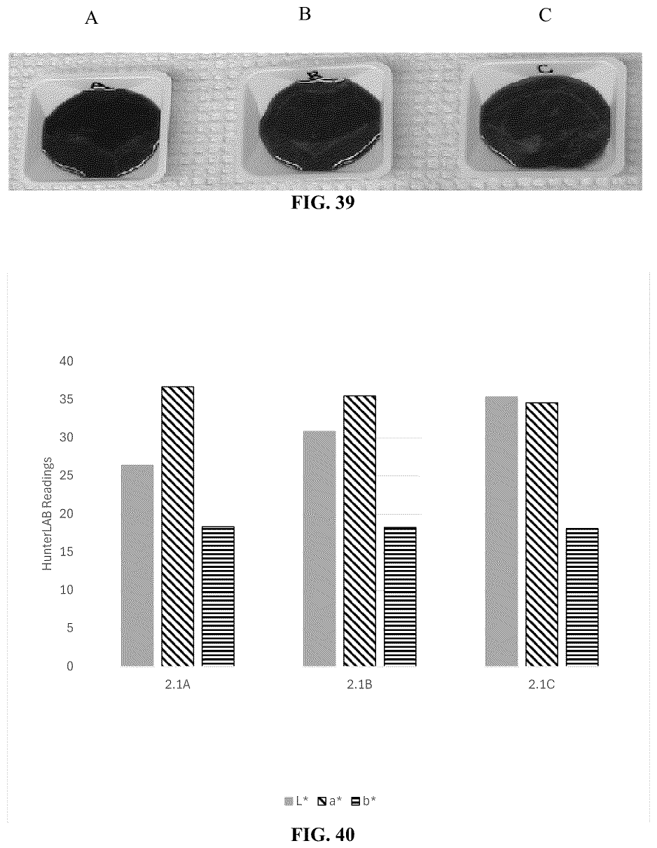

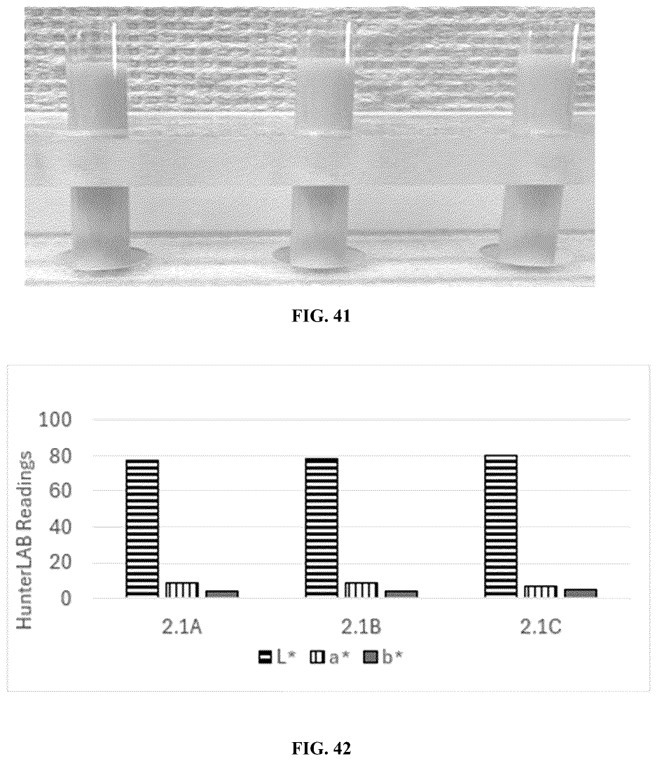

RE/GTE-derived red color showed good potential in food applications of slightly acidic to neutral pH, such as hard crack candy, sugar icing and milk. Its good heat stability allows it to survive the thermal treatment of hard crack candy (140-150° C.). It gave an intensive red color to the food at very low usage rates. The three batches of spray-dried powder didn't raise concern in consistency in applications by visual examination and Hunter L, a, b color indicator (FIGS. 37-42).

### Example 16

Stabilizers such as citrate and ascorbate (200 ppm each) were added individually and in combination to the hard crack candy formula containing RE/GTE-derived red color. Candies were left out in ambient in clear package for 8 days. Color of candy was checked visually.

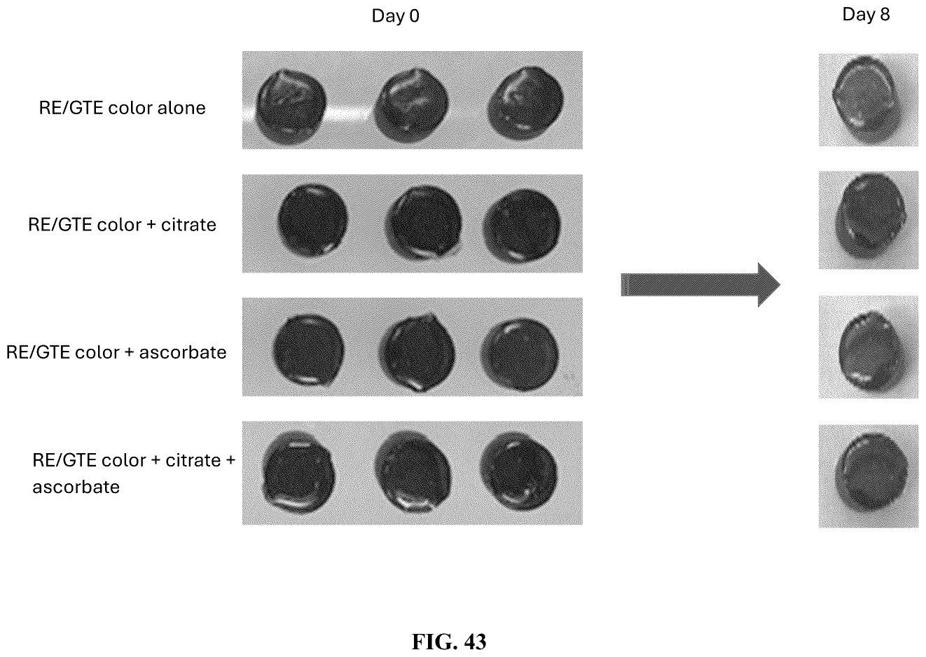

The candy with RE/GRE-derived red alone without stabilizers showed signs of losing its original red hue over time during the ambient storage with periodical exposure to light. On day 8, the color of candy turned orange. In the presence of 200 ppm of the stabilizers citrate and ascorbate (individually and in combination), the discoloration occurred to a lower extent, suggesting protection effect of citrate and ascorbate (FIG. 43). Citrate was more effective than ascorbate in preserving the original color of the candy. Further work can be conducted to optimize the level and ratio of citrate and ascorbate to achieve the desired protection. The role of citrate/ascorbate is believed to be related to their capability to regulate pH and inhibit oxidation through reducing and metal chelation.

### Example 17

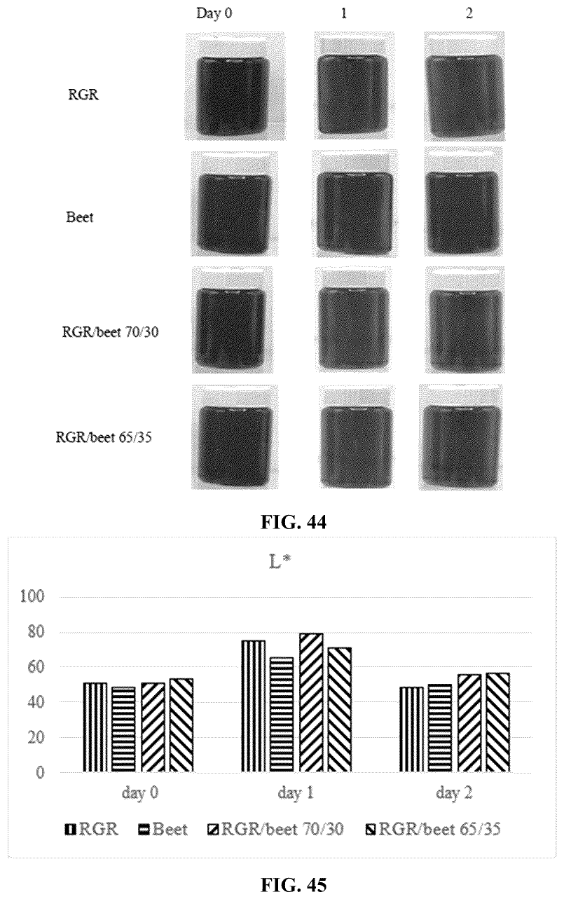

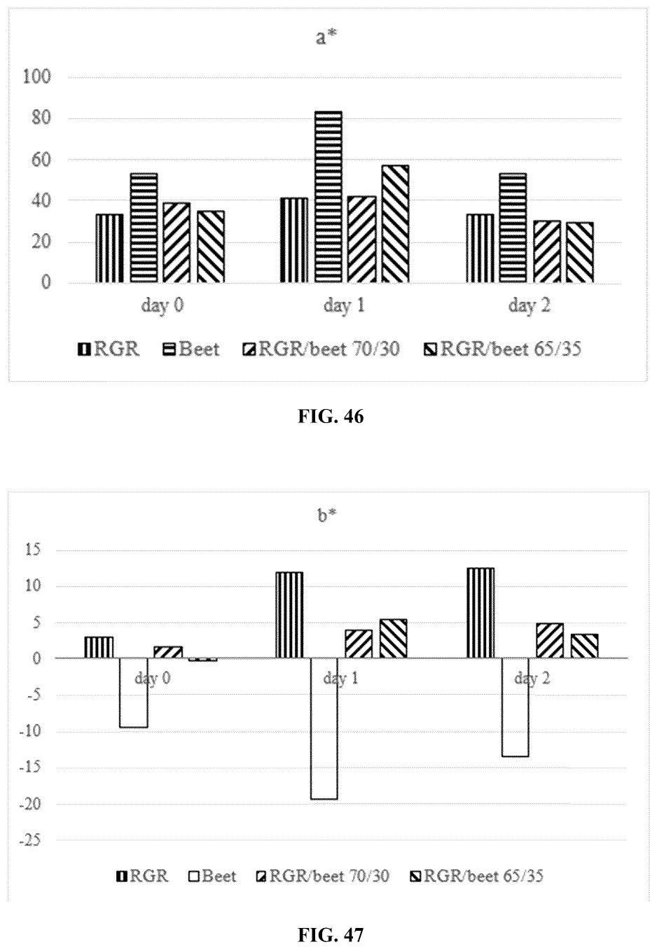

Spray dried RGR was reconstituted in DI water at a concentration of 0.2% (containing 300 ppm of added citrate). In a separate beaker, 0.2% of red beet powder (IFC COLOREZE Natural Food Color Powder Cat #NP BEETJ2) was reconstituted in DI water. Two RGR/beet blends were made in two clear air-tight vials at blending ratios of 73/30 and 65/35. Vials stored on a windowsill (strong sunlight exposure) and analyzed through visual observation after 24 hours as seen in FIG. 44. FIGS. 45-47 show the measured L*, a* and b* values for the aqueous solutions with a Hunter Lab colorimeter.

It was observed that best redness retention after sunlight exposure was achieved by blending RGR and beet. RGR alone shifted to brown while beet had too much pink/purple hue, as evidenced by low value of b for blue.

### Example 18

Further investigations compared RGR/beet blend with RGR and RB alone in hard crack candy (translucent application). Hard crack candy formulation is listed in Table 13. Both applications were left in ambient and windowsill storage in clear air-tight wrappers over the tested time.

TABLE 13
Hard crack candy formulation with treatment.

| Ingredient | % |
|---|---|
| Granulated white sugar | 67.6 |
| Light corn syrup | 25.8 |
| DI water | 6.4 |
| Color | 0.2 |
| TOTAL | 100 |

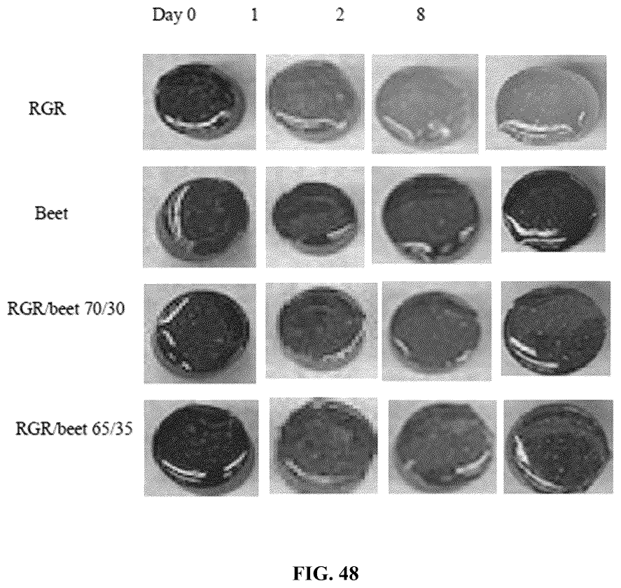

As shown in FIG. 48, best redness retention was achieved by RGR/beet blends, whereas RGR alone faded over time and beet alone showed a pink/purple tone instead of true red.

### Example 19

Betty Crocker™ Sugar Cookie Mix was prepared using the drop sugar cookie instructions on the container. Sugar cookie dough was chilled for 10 minutes then treated with 2% RGR, beet, and RGR/beet blend as seen in Table 14. Cookies were cooked at 375° F. for 7 minutes using a steam oven and cooled prior to visual analysis.

TABLE 14
Drop sugar cookie formulation with treatments.

| Ingredient | % |
|---|---|
| Chilled sugar cookie dough | 98 |
| Color | 2 |
| TOTAL | 100 |

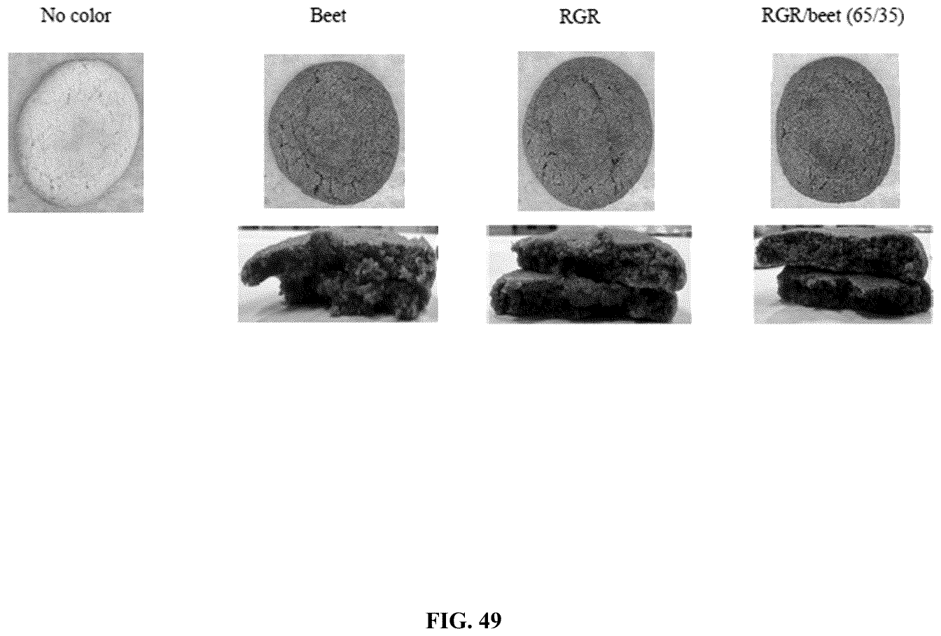

RGR/beet treated sugar cookie provided the best red color compared to RGR and beet alone (FIG. 49). Beet alone had consistent coloring throughout the cookie but was not an ideal red color and instead more pink/purple. Cookie with RGR alone was brown on the outside, and purple on the inside. RGR/beet blend allowed the colors reach an ideal red color for cookies.

### Example 20

Jimmies sprinkles were made and treated using the formulation listed in Table 15. The sprinkles were pipped onto parchment paper to mimic jimmies shape. Sprinkles were left to dry at room temperature for 24 hours before collecting for visual analysis. Retail sprinkles containing beet was obtained from a local supermarket for comparison.

TABLE 15
Jimmies sprinkles formulation.

| Ingredients | 1% color | 2% color |
|---|---|---|
| Powdered sugar | 83 | 82 |
| Light corn syrup | 7.7 | 7.7 |
| DI water | 8.3 | 8.3 |
| Color | 1 | 2 |
| TOTAL | 100 | 100 |

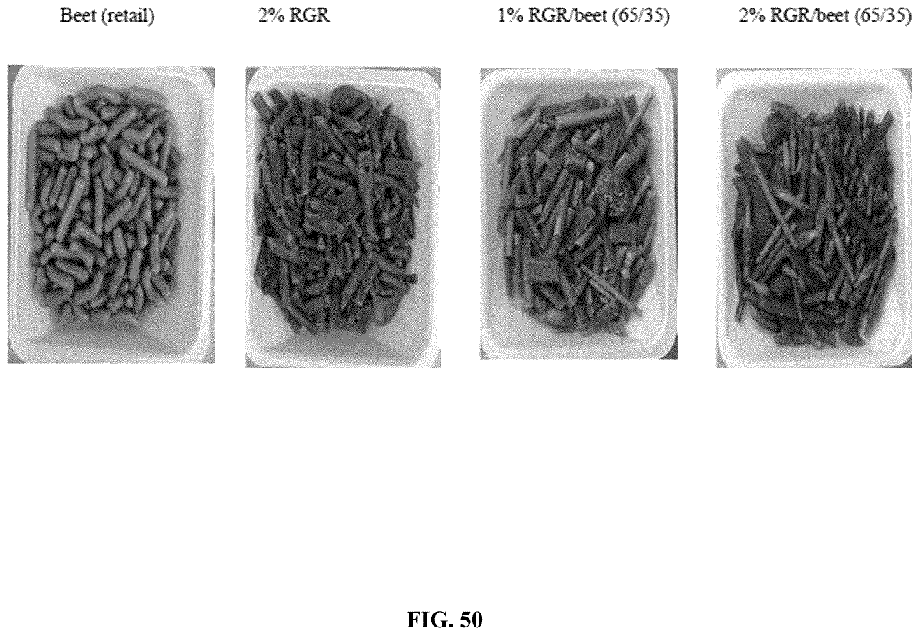

As shown in FIG. 50, RGR/beet blend gave a better redness in jimmies sprinkles compared to RGR and beet alone. Sprinkles with RGR alone appeared brown while sprinkles with beet alone appeared purple.

### Example 21

To test pH stability, 0.2% DI solution of RGR along and RGR/beet blend (65/35) were prepared and pH was adjusted using citric acid or sodium hydroxide.

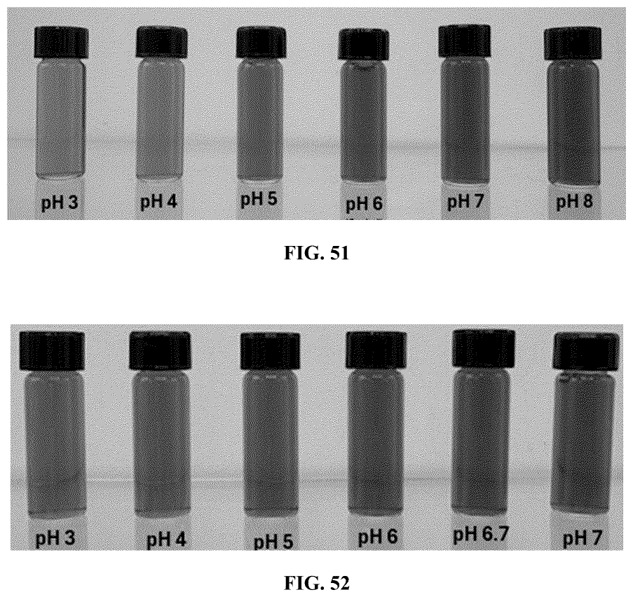

Blending with beet remarkably improved the pH stability of RGR. RGR alone had good red hue only under neutral pH (>6) and appeared yellow-orange under lower pH (see FIG. 51). Upon blending with beet, it delivered the red hue even at lower pH (see FIG. 52).

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

It should be further appreciated that minor dosage and formulation modifications of the composition and the ranges expressed herein may be made and still come within the scope and spirit of the present invention.

It is also to be understood that the formulations and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Where a range of values is provided, it is understood that each intervening value, to the tenth of the unit of the lower limit unless the context clearly dictates otherwise, between the upper and lower limit of that range, and any other stated or intervening value in that stated range, is encompassed within the scope of the present disclosure. The upper and lower limits of these smaller ranges may independently be included in the smaller ranges, and are also encompassed within the scope of the present disclosure, subject to any specifically excluded limit in the stated range. Where the stated range includes one or both of the limits, ranges excluding either or both of those included limits are also included in the scope of the present disclosure. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, 10) contained within the range. In this specification and the appended claims, the singular forms “a,” “an” and “the” include plural reference unless the context clearly dictates otherwise. All combinations of method steps or process steps as used herein can be performed in any order, unless otherwise specified or clearly implied to the contrary by the context in which the referenced combination is made

To the extent that the terms “includes” or “including” or “have” or “having” are used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A” or “B” or both “A” and “B”. When the Applicant intends to indicate “only A or B but not both” then the term “only A or B but not both” or similar structure will be employed. Thus, use of the term “or” herein is the inclusive, and not the exclusive use. Also, to the extent that the terms “in” or “into” are used in the specification or the claims, it is intended to additionally mean “on” or “onto.” In this specification and the appended claims, the singular forms “a,” “an” and “the” include plural reference unless the context clearly dictates otherwise.

The foregoing description has been presented for the purposes of illustration and description. It is not intended to be an exhaustive list or limit the invention to the precise forms disclosed. It is contemplated that other alternative processes and methods obvious to those skilled in the art are considered included in the invention. Including, but not limited to, related process and methods used effect color change other than red (i.e. caramel color), and including, but not limited to, related process using other components containing catechins which are combined with components having antioxidative properties. The description is merely examples of embodiments. It is understood that any other modifications, substitutions, and/or additions may be made, which are within the intended spirit and scope of the disclosure. From the foregoing, it can be seen that the exemplary aspects of the disclosure accomplish at least all of the intended objectives.

1. A method of providing a desired color to a food product comprising the step of adding a composition that contains a first polyphenol and a second polyphenol, wherein the first polyphenol is a phenolic diterpene, to the food product.

2. The method of claim 1, wherein the first polyphenol comprises rosemary extract and the second polyphenol comprises green tea extract.

3. The method of claim 2, wherein the desired color is red or caramel.

4. The method of claim 2, wherein the composition has a concentration of about 0.2% to about 2% in water.

5. The method of claim 2, wherein the composition can be added at any stage of manufacturing the food product.

6. The method of claim 1, wherein the composition further comprises a stabilizer.

7. The method of claim 6, wherein the stabilizer is citric acid or citrate.

8. The method of claim 3, wherein the composition further comprises a color blender.

9. The method of claim 8, wherein the color blender is beet powder.

10. The method of claim 1, wherein the composition further comprises an ingredient for adjusting pH range of the food product.

11. The method of claim 9, wherein the food product maintains the desired color for at least two weeks without protection from light.

12. The method of claim 1, wherein the food product retains the desired color when exposed to heat up to at least 212° F.

13. The method of claim 9, wherein the food product has a pH of about 3.0 to about 8.0.

14. A method of adding red coloring to a food product comprising adding a composition comprising rosemary extract and green tea extract to the food product.

15. The method of claim 13, wherein the composition further comprises beet powder.

16. The method of claim 13, wherein the food product maintains the desired color for at least two weeks without protection from light.

17. The method of claim 13, wherein the food product retains the desired color when exposed to heat up to at least 212° F.

18. A method of increasing the redness of a food product comprising adding a composition comprising at least one antioxidant and at least one catechin to a food product.

19. The method of claim 18, wherein the at least one antioxidant comprises rosemary extract and the at least one catechin comprises green tea extract.

20. The method of claim 19, wherein the composition further comprises beet powder.
